(19) United States
(12) Patent Application Publication
(10) Pub. No.: US 2004/0007121 A1
(43) Pub. Date: Jan. 15, 2004

(54) System and method for reuse of command and control software components

(76) Inventors: Kenneth P. Graves, Ramona, CA (US); Ronald Roy, San Diego, CA (US); Darius F. Miller, San Diego, CA (US)

Correspondence Address: SCHNADER HARRISON SEGAL & LEWIS, LLP, 1600 MARKET STREET, SUITE 3600, PHILADELPHIA, PA, 19103

(21) Appl. No.: 10/444,920

(22) Filed: May 23, 2003

Related U.S. Application Data
(60) Provisional application No. 60/382,799, filed on May 23, 2002.

(51) Int. Cl. G06F 17/00; G06G 7/00; G01C 21/36; G01C 21/34; G01C 21/32; G01C 21/30; G01C 21/28; B64D 1/04; G01C 21/26; F41F 5/00

(52) U.S. Cl. 89/1.11; 701/200; 705/400

(57) ABSTRACT

A module combat command and control system is disclosed having a concrete layer and a plurality of abstracted layers. Various components can be interchangeably associated with the abstracted layers to form different applications, such as a terrain mapping application, a netted fires applications, and the like.

This application is based, and claims priority to, provisional application having Ser. No. 60/382,799, a filing date of May 23, 2002, and entitled An Adaptive Intrusion Detection System for a Computer Network.

### GOVERNMENT RIGHTS

This invention was made with government support under Contract Nos. DAAE30-01-C-1004, DAAE30-01-C-1049, DAAE30-99-C-1055, DAAE30-02-C-1009, awarded by U.S. Army Armaments Research, Development and Engineering Center of Pictinny Arsenal, N.J. The Government has certain rights in the invention.

### FIELD OF THE INVENTION

The present invention relates generally to graphical user interfaces, database management systems, and artificial intelligence-based software applications and more particularly the present invention is directed to a composable, scaleable application building architecture for reuse of software components for military command and control-and for Homeland Security application..

### BACKGROUND OF THE INVENTION

Prior software development for military command and control systems has focused on building large, monolithic applications, which generally require much expense and effort to modify. For example, the Army's Battle Command System (ABCS) consists of five major software applications, which perform maneuver command and control, artillery fire control, intelligence operations, logistics support, and air defense management. Each of these applications was built by a major system integrator company. Each of the applications has a closed architecture, i.e., third-party developers cannot develop new or improved software components to improve the performance of the application. Typically there are no published application programmer interfaces to allow third party developers to interface to the architecture or application. Any improvements must be performed by the original contractor. This is typically called “stovepipe” development.

The five Army applications have great difficulty in passing data back and forth between themselves since they all have propriety internal data structures. The only currently feasible means to pass data between the applications is to use a common messaging format, such as the Joint Variable Message Format (JVMF) system. Only small subsets of the entire message set are implemented within each of the five applications, so full capability to transfer data is not available.

Each of the five Army applications has only one functionality set. This means that the maneuver command and control application cannot be used to perform any of the functions that the other applications perform. In other words, one application cannot be reconfigured, using different software components, to do the functions of one of the other applications. Neither can one take a component which has the same function in all of the applications, such as a map display component, and use it in other applications. Each application has its own implementation of a map display component, with different languages, and different software interfaces. Within the Homeland Security environment, much the same problem exists, where township level automated command and control systems cannot interface to higher level county and state systems. Hospitals and schools have no means to interface into command and control systems with reports of illnesses as might be caused by chemical or biological agents. The current monolithic architecture approach to developing command and control applications is very costly, and results in much redundant effort as each applications develops its own version of such functionally similar components as map displays, message processors, databases, etc.

Accordingly, there is a need for a command and control system that allows multiple developers to develop components which can fit into a common architectural framework, and allows developers or users of applications to choose from a large repository of components in order to create different applications, such as intelligence operations and control or artillery fire control, by using different components.

### SUMMARY OF THE INVENTION

Embodiments of the invention provide a component-based computer architecture for command and control systems. The system may include a repository of components to create different applications.

Two different applications might use common message processing and map display components. However, an intelligence operations application would add certain components from the repository, such as an enemy weapon systems database and order of battle component. These two components would not be needed in an artillery fire control application which would, on the other hand, need a weapon target pairing component, and a ballistic kernel component, but not the intelligence components. Thus, instead of a monolithic application architecture which uses no common components, a number of different applications can be constructed, using some common components and some domain specific components, all of which are contained in a repository, or which can be built to fit within the repository, and which can interface to the architecture.

The present invention may be implemented, for example, as a combat decision support system, which is identified herein by the name C3Core. C3Core consists of graphical user interfaces, database management systems, and artificial intelligence-based software applications that, in a presently preferred embodiment, provide a warfighter/commander or an emergency operations center controller with fully integrated and scalable decision support capability for conducting network centric, distributed operations. C3Core provides the capabilities to process, analyze and exchange combat information within an operational architecture that includes Army Battle Command System (ABCS) messaging, tactical command posts, and battle staffs using Force XXI Battle Command, Brigade and Below (FBCB2) information streams. It provides the same capabilities to Homeland Security Tier 1 to Tier 4 operations centers using commercial communications standards and information streams.

When employed by a military command group such as a Brigade Combat Team Commander and staff, C3Core is capable of managing the fires and effects of field artillery cannons and rockets, mortars, naval surface fires, and close air support. It can be used as a battlefield management and decision support system of mobile, dispersed, multi-functional nodes conducting non-linear, distributed operations. C3Core can enable automated planning, coordination, and control of full-spectrum fires and effects with full integration of maneuver operations, intelligence and logistics efforts. In the Homeland Security role, C3Core is capable of tracking and monitoring first responder assets, critical security sites, managing response to man-made and natural disasters, and portraying threats.

C3Core may automate many of the time critical functions and tasks performed by Brigade Combat Team staff, i.e., course-of-action analysis, movement planning, fire planning, tactical fire control, and fires coordination. C3Core may enhance battlefield visualization and provides for total asset visibility for operations, support, and evaluation of mission critical tasks. C3Core may be used to manage and support the timely exchange of battlefield information, effect coordination, and targeting required to integrate fire support assets. It may filter, sort, and process requests for fires and effects from sensors. It may prioritize lethal and non-lethal engagements based on target selection standards, commander's attack guidance, target characteristics, target value analysis, weapon system availability, and weapon capabilities. C3Core may also provide for positive control of fires based on troop safety criteria and fire support coordination measures. It may generate a fire order based on the optimum fires solution. C3Core may be configured as a scalable system to support combat functions from Commander to shooter, and is capable of establishing and implementing sensor-weapons pairings.

In the Homeland Security domain, C3Core automates the time critical functions and tasks performed by emergency response planners such as response analysis and wargaming, emergency evacuation plans, and hazard response staging. It enhances the situation awareness amongst emergency operations center personnel by providing a common picture of the relevant homeland security situation and providing visibility of ongoing and planned responses to hazards and threats, as well as logistics information about response assets available for use. It provides positive control of all response assets, and generate response plans in real time that reflect the best available response to any particular threat. C3Core is scaleable from individual emergency responders to state and regional command centers.

C3Core can be implemented as a composable, component-based, plug and play software architecture, allowing insertion of new software decision aids or components built by third party developers. With its instrumented graphical user interface (GUI), it can provide an ideal testbed for development of team training, new tactics and doctrine, and for experimentation with new visualization concepts.

### BRIEF DESCRIPTION OF THE DRAWINGS

FIG. 1 depicts a modular combat command control system in accordance with the present invention;

FIG. 2 depicts a schematic view of the system of FIG. 1;

FIG. 3 depicts another schematic view of the components and plug-ins of the system of claim 1;

FIG. 4 depicts a prior art route finding method;

FIG. 5 depicts a VMAP analysis using rank ordered terrain features according to an illustrative embodiment of the invention;

FIGS. 6A-D depicts a slope analysis according to an illustrative embodiment of the invention;

FIGS. 7A-G is a flowchart for a classification and fusion algorithm according to an illustrative embodiment of the invention;

FIGS. 8A-E is a flow chart for a flood algorithm to obtain the time needed to reach designated points according to an illustrative embodiment of the invention;

FIGS. 9A-C depicts a method of determining an array of waypoints according to an illustrative embodiment of the invention;

FIGS. 10A-D depicts a corridor mobility analysis according to an illustrative embodiment of the invention;

FIGS. 11A-C is a graph depicting a line of sight analysis according to an illustrative embodiment of the invention;

FIG. 12 is a matrix for a line of sight analysis according to an illustrative embodiment of the invention;

FIG. 13 shows the result of a circular line of sight calculation according to an illustrative embodiment of the invention;

FIG. 14 is a flow chart of a netted fire method submitted in accordance with the present invention;

FIG. 15 is a schematic view of the emission processing system of FIG. 14;

FIG. 16 is a flow chart of another embodiment of a netted fire system in accordance with the present invention;

FIG. 17 is another embodiment of a netted fires system in accordance with the present invention;

FIG. 18 is a modification of the netted fires system depicted in FIGS. 14-17;

FIG. 19 is a modification of the netted fires system of FIGS. 15-17;

FIG. 20 is a modification of the netted fires system shown in FIGS. 15-17;

FIG. 21 is modified netted fires system in accordance with the previous figures;

FIG. 22 is a network bridge for a combat control system in accordance with the present invention;

FIG. 23 is a schematic view of how the network bridge of FIG. 22 maintains shared data;

FIG. 24 is a graphical user interface for controlling a the network bridge of FIG. 22;

FIG. 25 shows a schematic operational view of the network bridge of FIG. 22

FIG. 26, 27, 28, 29 shows actor engine for a modular combat control system in accordance with the present invention.

### DETAILED DESCRIPTION OF THE INVENTION

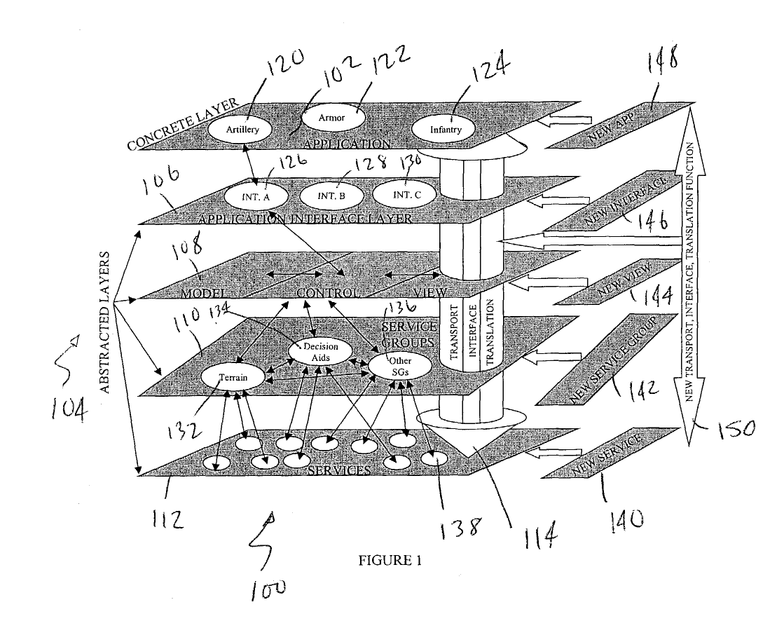

In FIG. 1 there is illustrated a form of the invention that is presently preferred, including embodiment of a combat decision support system 100 which is identified herein by the name C3Core. The referenced architecture of the C3Core 100 includes a concrete layer 102 in a plurality of abstracted layers 104. This architecture, including the abstraction layers, allows for consistency, reuse, and the addition of new features within the referenced architecture.

The abstracted layers 104 include an application interface layer 106, a model control view layer 108, a service groups layer 110, and a services layer 112. Each abstraction layer serves as an interface framework for new software services, i.e. plug-ins, and new service groups, i.e. components, views, application interfaces, and applications. A backplane 114 connects the layers 102, 108, 110, and 112 and provides for transport, an interface, and translation services so that the various layers can communicate with each other.

The concrete layer 102 includes various real world military elements, such as artillery 120, armor 122, and infantry 124. Similarly, the application interface layer 106 includes any necessary application interfaces that are necessary to communicate with the concrete layer elements. For example, first interface 126 may be provided to interface with the artillery element 120. Similarly, second interface 128 and third interface 130 may be provided to interface with other concrete layer elements. As used herein, the term interface is defined as the point at which a connection is made between two elements so that they can work with each other or exchange information, or software that enables a program to work with the user, such as a user interface, which can be a command line interface, menu driven interface, or a graphical user interface, with another program such as the operating system, or with computer hardware. Moreover, the term interface includes a card, plug, or other device that connects pieces of hardware with the computer so that information can be moved from place to place.

The service groups layer 110 includes various plugin, such as terrain plugin 132, decision aids plugin 134, and other SGs 136. A component on the service group layer includes a group of services 138 taken from the services layer 112 that work together to produce a coherent function, such as the terrain analysis tool service group 132. At this level, the terrain analysis component 132 would be assessable by other components such the decision aid component 134, intelligence indicators (not shown), a maneuver planning component (not shown), and the like. Each of these other components will be comprised of various plug-ins 138 from the services layer 112. Throughout the implementation architecture, a common transport mechanism 114, such as CORBA, COM, or dispatch is used and specified for use. Common data dictionaries (translation) run orthogonal through the architecture to ensure that data is coherent at all levels within the architecture.

The architecture also allows the replacement of a plugin or component by a new and/or improved version of the component without affecting the remainder of the components in the architecture. The bottom two levels, service layer 112 and service groups layer 110 comprise the component repository of the architecture. Similarly, the model control view layer 108 and the application interface layer 106, along with the transport and translation backplane 114, represent the architectural framework.

In this way, a new service 140, a new service group 142, a new view 144, a new interface 146, a new application 148, and a new transport, interface, transport function 150 can be replaced or added into the architecture.

The C3CORE 100 includes a particular programming language and domain (C++and the command and control domain) are included in order to prove the robustness of the architectural design. The C3Core 100 avoids the “stovepipe designs” of current military command and control systems, which are domain specific to such domains as maneuver, or fire support, or logistics; and which do not interoperate well with each other. The C3Core 100 developed plugin components which perform functions for all the military command and control areas, and allow developers and users to pick and choose the various plug-ins to suit their needs in order to develop hybrid command and control systems which incorporate aspects of all domains, and which fully interoperate.

Since no particular domain or technical echelon is required for C3Core 100 to work properly, the utility of the C3Core implementation at different levels and in different technical roles, from individual cruise stations or a weapon system such as a tank, to a commander's work station in an operation center, have demonstrated utility. In addition, the C3Core architecture, with slightly different arrangements of the plugin components, are useful for counter-terrorism and security applications.

When using the concept of a plugin architecture, C3Core 100 furthers the concept of software reuse for multiple applications. One aspect within C3Core is an architecture which not only contains numerous command and control components which can be reused, but which also contain a repository of components which can be used, along with the core backplane to tailor various command and control applications for multiple uses. For instance, by adding and removing various components from the repository, the architecture can be used to configure a decision aiding application for artillery tactical fire control for use on a desk top computer. By using other components, a decision aiding application can be built for mortar fire direction on a palm device.

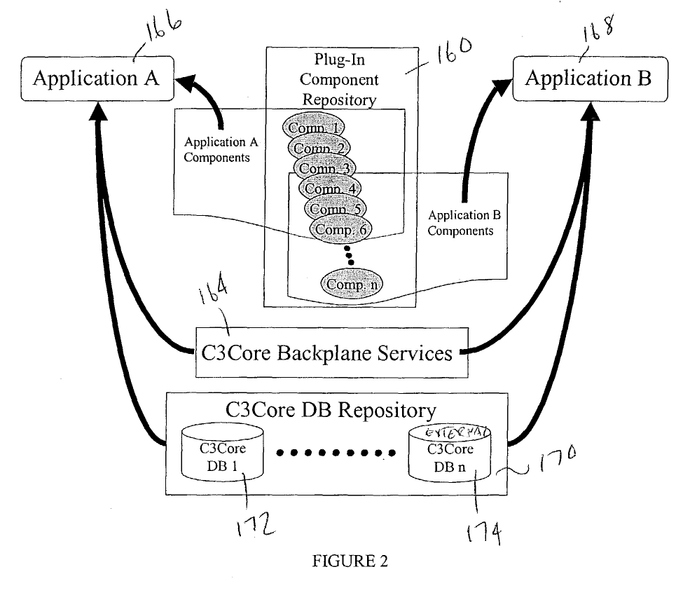

In FIG. 2 there is shown an exemplary embodiment of how the plug-in architecture of C3Core 100 described in FIG. 1 is used in practice. The component repository 160 contains all of the plug-ins and components 138 which are available within the architecture. Each component 162 is accompanied by a description of its functionality (what it does), a list of the plug-ins that make up the component (dependencies), and an interface document. The backplane services 164 contain the transport and translation mechanisms of the implementation architecture 114, as well as higher level controls 102, view 108, and application interface layer 106, if any. The backplane 164 is essentially the architectural framework into which the components can be placed and arranged in order to form different applications. The backplane 164 is required for any application 166 or 168 built from components contained within the repository 160. A database repository 170 may include any number of databases 172 built specifically for the architecture, such as a common operational picture database, a targets database, or external databases.

Databases built specifically for the architecture are contained in the database repository 170, and may be used or not used, depending on the need of the application builder or user. The databases 172 are similar in nature and use to the components, and are accompanied by a description of the database functionality (what it does), the database schema (what is in the database), and an interface document. The databases 172 conform to the translation and transport mechanisms 114 of the architecture backplane 164. An external database 174, which conforms to the translation and transport mechanisms 114 of the architecture may be included within the database repository 170, and then used as one of the domain specific databases created specifically for use in the architecture.

In practice, given the backplane 164, the component repository 160, and the database repository 170, a software developer can define what he wants his particular application to do in terms of functionality, then search the component and database repository for components that match all or part of the functionality required for his application. When component matches are found, the developer pulls the components from the repository and places them into the architecture backplane. The same action is performed with databases. If there are some desired functions that the developer needs which are not contained within the component or database repository, the developer can then design and create components to perform those functions. The components will conform to the architectural framework requirements for interfaces and transport, and then be placed into the backplane. Assuming that the developer's new components function property, they can then be placed permanently into the component repository as new components available for reuse in other applications.

Components in the repository can also be used within other architectures or applications. Since each component has an interface description and functional description, it can be taken from the repository, a wrapper is constructed around it to allow interface to another architecture, and then it can be inserted into a different architecture.

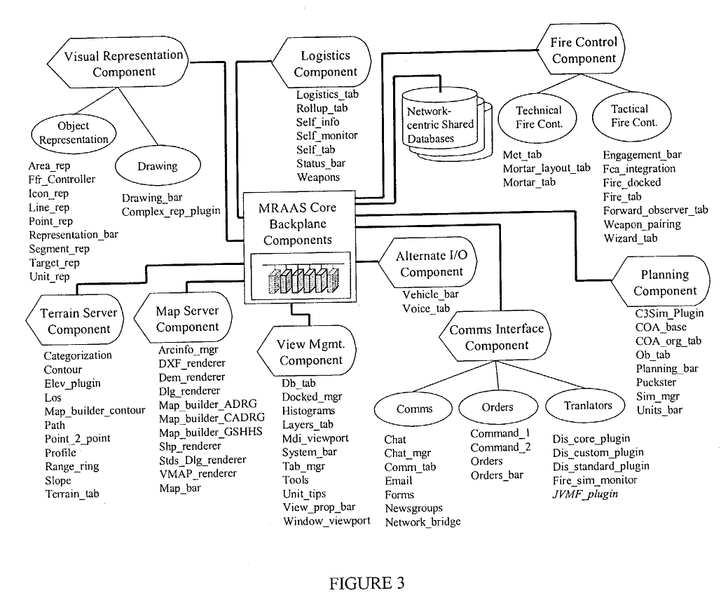

A presently preferred embodiment of the plug-in architecture of C3Core 100 is shown in FIG. 3. This shows the top level of the architecture 160, the backplane 164, the major components or service groups, and the individual plug-ins of importance. By using the backplane 164, and incorporating one or more of the plug-ins or service groups 162, any developer or user can create new, customized applications 166, 168 for their use. For developers, it is easy to develop new plug-ins that use the backplane 164, and to add components 162 to the architecture. Third party developers can readily place new components into the architecture.

The following paragraphs briefly discuss the major functionality of the larger components.

The C3Core software architecture is a novel approach to the development of software applications for command and control. The architecture is designed as a set of services and plug-ins which are managed by a very small backplane, such that the services and components can be arranged, added, or subtracted in order to produce different applications according to the varying needs of system developers and users. In a preferred embodiment of the invention, C3Core is a reference architecture, which facilitates a scaleable, composable, application building framework for the reuse of software components of interest to command and control. In a presently preferred embodiment, C3Core consists of a repository containing separate plug-in components, each of which may or may not be present within any given application. Presently, approximately 150 plug-ins have been contemplated, but any number is within the scope of the invention. The addition or subtraction of the components may be done by a developer, but may also be done by a user, since addition or removal of components does not necessarily require the software to be recompiled. A communications backplane allows the components to communicate with each other in any application created with C3Core components, and also manages the start up of the components in the proper order. Additionally, components from the C3Core architecture and repository can also be used in other applications outside C3Core.

Advantageously, C3Core may contain one or more of the following key characteristics as a composable, scaleable, application building framework for software reuse:

Platform independence—C3Core does not specify any particular operating system or machine type. For example, specifying MicroSoft's COM as the transport layer restricts the architecture to a particular operating system (WindowsXX), from a particular vendor for the Intel platform. However, building around an open standard such as CORBA or Java's Virtual Machine, though not platform specific, does specify a particular implementation. Each plug-in component has the ability to be “wrapped” in any desired container to achieve interoperability.

Language independence—The current defacto standard implementation language currently is C++ with a gradual shift towards Java. Just a few years ago Ada was the standard language for fielded systems; over time the language of choice will change. C3Core remains imutable to these changes by not specifying a particular implementation language but providing means for applications of different languages and dialects of a particular language to inter-operate.

Open Architecture—Standards such as IEEE and ISO claim to be “open standards,” though the distribution of these standards is a costly process in which implementations are still held to be proprietary at the API level. Within collaborative environment between programs, contractors and agencies, the standards on which C3Core software is built are openly and freely available. Software components which are brought into C3Core have open interfaces, which are documented and maintained. The actual source code is held confidentially without breaking this paradigm.

Scaleable across echelons and domains—C3Core plug-in components are designed and specified to provide generic services which may be used in both similar and diverse applications. This prevents the development of a “Stove Pipe” architecture or implementation which is restricted to one particular domain. The C3Core reference architecture is not dictated by the application or the domain, and is domain and echelon independent.

Provides facilities to readily expand, augment and re-use components—One of the fundamental driving forces for the development of the C3Core architecture is to promote component heterogeneity and re-use. The C3Core architecture is capable of accepting new plug-ins and allows for the browsing of the existing repository. Automated means exist within the C3Core architecture to ensure compliance, availability and visibility of components.

Ability to work within different environments—The C3Core architecture exists at an abstraction layer above the domain and is not be bound by specific applications or implementations. A plug-in service, or group of plug-ins (service group) is abstracted enough to provide the generalities required to exist across domains. For example, a button is a button whether it exists within an embedded weapon system or within a Commander's situational awareness display. The purpose and behavior of the button is well understood within a domain independent context.

FIG. 1 illustrates an embodiment of the C3Core reference architecture, and how abstraction allows consistency, re-use, and addition of new features within the architecture.

The abstraction of the C3Core reference architecture allows implementation of a quite successful instantiation of the architecture. This instantiation is called the C3Core Command and Control Testbed. In this testbed, a particular language and domain (C++ and the command and control domain) have been selected in order to prove the architectural design. This particular instantiation of the C3Core architecture advantageously avoids the stovepipe designs of current military command and control systems, which are domain specific to such domains as maneuver, or fire support, or logistics; and which do not interoperate well with each other. The C3Core implementation developed plug-in components which performed functions for all of the military command and control areas, and allowed developers and users to pick and choose the various plug-ins to suit their needs in order to develop hybrid command and control systems which incorporate aspects of all domains, and which fully interoperate.

Since particular domain or tactical echelon is required for C3Core to work properly, the utility of the C3Core implementation can be demonstrated at different levels and in different tactical roles, from individual crew-station on a weapon system such as a tank, to a commander's workstation in an operations center. The same architecture, with slightly different arrangements of plug-in components can become useful for counter-terrorism and security applications.

By using the concept of a plug-in architecture, C3Core is furthering the concept of software reuse for multiple applications. One aspect within C3Core is an architecture which not only contains numerous command and control components which can be reused, but which also contains a repository of components which can be used, along with the core backplane to tailor various command and control applications for multiple uses. For instance, by adding and removing various components from the repository, the architecture can be used to configure a decision aiding application for artillery tactical fire control for use on a desktop computer. By using other components, a decision aiding application can be built for mortar fire direction on a palm device.

FIG. 2 shows how the C3Core architecture plug-in concept works for development of different applications using different components from the repository, the C3Core backplane, and various C3Core or other databases for information management.

A presently preferred embodiment of the plug-in architecture of C3Core is shown in FIG. 3. This shows the top level of the architecture, the backplane, the major components or service groups, and the individual plug-ins of importance. By using the backplane, and incorporating one or more of the plug-ins or service groups, any developer or user can literally create new, customized applications for their use. For developers, it is quite easy to develop a new plug-in that uses the backplane, and to add components to the architecture. Third party developers from other companies and government agencies have been quite successful at placing new components into the architecture.

The following paragraphs briefly discuss the major functionality of the larger components.

Fire Control

This component can allow the user to perform all required functions associated with the selection of appropriate weapon systems to engage one or more targets. A number of plug-ins comprise this component in order to provide a complete fire control package which encompasses the entire chain of events from designating a target for attack (forward observer) to tactical fire control and sending of the fire missions to individual weapon platforms. Manual, semi-automated, or fully automated attack of targets can be performed. Algorithms within the component account for a variety of conditions affecting optimal target attack, such as logistics states, number of missions per hour, target selection standards, attack guidance, and many other factors. Individual targets can be processed at the rate of approximately 5 per second. The component accounts for both indirect (BLOS, NLOS) and direct fire systems, and will attempt to match the appropriate number and types of weapons for any given target array.

Map Server Component

This component allows the user to view and manipulate all NIMA and USGS maps, as well as commercial maps produced by the major commercial mapping system vendors. Multiple maps are supported, as well as GPS navigation, rotating maps for orientation, and moving maps. Distance measuring and azimuth utilities allow the user to remain oriented at all times.

Terrain Server Component

The terrain server component performs a variety of calculations which allow the user to display such terrain-related data as mobility corridors, line of sight, contour maps, Restricted and Severely Restricted terrain, fastest routes, and mobility range rings. The mobility and terrain analysis algorithms contained in the component make use of both elevation data and feature data contained in either Vector Maps (VMAP) or Vector Interim Terrain Data (VITD). Users can also define and use their own terrain objects. Much of the terrain server component has been subjected to formal VV&A with the USMC and Naval Postgraduate School, and the component is currently fielded (version 3.0) with the USMC's command and control personal computer (C2PC) as the Decision Support Toolbox.

Comms Interface Component

This component serves as a translator for different messages external to the architecture, such as distributed interactive simulation (DIS), Joint Variable Message Format (JVMF), and other messages; and also allows C3Core users to communicate to other C3Core users via email, chat, newsgroups, and instant messenger. This component is also the source of C3Core's capability to share databases such that peer-to-peer, versus client-server, communications are the norm. This ensures that any data server which fails does not affect the overall shared data within C3Core; the system is self-healing. As long as one system remains operational all shared data is maintained, allowing rapid restoration of shared databases in the case of system failure. The component also facilitates the issue and receipt of tactical frag orders, which can be displayed both graphically on the map display, and in text format. Incoming messages from external sources are automatically translated into object data and attributes which can then be stored in C3Core tactical databases. Objects within C3Core can be translated into messages which can then be sent to external sources in the appropriate format. This interface can currently process between 1,500 and 2,000 messages per second, depending on the complexity of the message.

Visual Representation Component

This component allows the user to manipulate his visualization of data contained within the C3Core common operational picture. The component also supports drawing and display of all MIL-STD-2525D tactical symbology. Visualizations currently supported include: direct/indirect fire footprints; unit physical footprints; density of fires; command relationships; combat power; and movement history.

View Management Component

This component allows the user to manage and display multiple databases; to hide or show loaded databases; to share databases; to automatically assign tactical objects to different layers within a database; to selectively hide or display the different layers within a database; and to selectively filter tactical units by echelon or type. It also allows the user to customize any C3Core application by turning different tools on and off within the application. This component provides the user or software developer with a variety of data monitoring tools to monitor different aspects of system performance.

Planning Component

This component, which is still in beta form, allows the user to create and then wargame a simulated course of action. Intelligent agents within the component allow red and blue forces which the user creates to move on objectives, and also engage each other. Timelines, tasks, attrition, and ammunition consumption are some of the products which result from the wargame. Within this component, the user can create an enemy order of battle and friendly task organization. These can then be used during actual operations for monitoring of unit status. As part of the planning process, the user also is given a checklist which will guide him through the steps of the Intelligence Preparation of the Battlefield (IPB) process. Initially a largely manual checklist, except for terrain analysis, as this component becomes more mature, the IPB process will become more automated, and will include templating. This will be used to feed the simulation for course of action wargaming.

Logistics Component

This component allows the user to continuously monitor the status of all weapon systems and units that he wishes to monitor. The user may monitor unit rollups, or drill down to individual vehicles. All classes of supply, as well as maintenance and activity status are tracked and available to the user. The user can filter for any class or classes of supply to be displayed. The user can also have Class III, V, and personnel status displayed next to unit icons on the map display for quick reference. Within the component, there is a small subcomponent which tracks consumption rates, and performs predictive analysis on these consumption rates in order to alert the user to impending logistics problems which may occur in the near future. This allows the user ample time to modify his logistics plan and/or perform emergency resupply. Another small subcomponent allows the user to manipulate basic load information in order to determine the best mix of munitions to defeat a hostile force array.

Track Management Component

The track management component allows a C3Core application to interface to various sensor systems, such as acoustic or seismic, fuse raw sensor data into possible target tracks, and update the C3Core COP with track information. Algorithms within the component account for various track management issues such as false positives, error ellipses, latency, and vehicle classification in order to perform the required data fusion. Once a track is generated and posted to the common operational picture, it can be targeted provided that target selection standards are met in accordance with attack guidance contained in the fire control component.

Network Centric Shared Databases

While not actually components, these databases are common to each operational C3Core application. The COP database is shared by all systems; individual users may tailor their view of the COP data. Fire mission data is contained in this COP, as is all logistics data. Attack Guidance is also a shared database, which is common to all users within a CDAS network. Users may create additional databases, for example a tactical graphics database to support an operation, and share them across the network. A user-created database has the same advantages as one of the system-created databases, i.e., once the user shares the database, the data will not be lost if his system is disabled; another machine will become the “owner” of the data and continue to maintain the data.

BackPlane Components

The C3Core backplane components contain the basic plug-in registering facility which allows components or plug-ins to run within the C3Core architecture environment.

FIG. 3. C3Core Plug-in Architecture With Backplane, Major Components (Service Groups), Subcomponents, and Individual Plug-ins.

Plug-in Components

C3Core's list of plug-in components in a presently preferred embodiment includes the following. A system may contain any number of these plug-ins. All plug-ins are normally included when the application is provided to the user. If the user does not need a plug-in, he can remove it from the plug-in directory, and the plug-in will not be activated when the application is started. The user may replace a plug-in in the directory, and when the application is restarted, the plug-in will be activated.

1. Alert GUI: Provides the capability to send and receive text alerts to the Fort Knox SC-4 Command and Control Surrogate system, when used in Future Combat Command and Control (FCC2) experiments. This is a small GUI window in which the user can input a text alert, and then send the alert to various addresses in his address book.

2. Alerts: Underlying logic module which provides alerting mechanisms and logic for the Alert GUI.

3. Alerts_docked: GUI component which serves as an alert log. This GUI can be undocked from the CDAS application GUI, and used as a floating GUI, which can be sent to a different desktop, or placed on the computer screen at a different location than the main application. All incoming and sent alerts are listed in the log, and can be sorted by date, time, or other sort criteria. The Alert GUI, Alerts, and Alerts_docked components are normally used in conjunction with each other. They are only used during FCC2 experiments, where communication with the SC-4 is required.

4. Arcinfo_mgr: GUI and database component which allows the user to access and cause to be displayed any digital map data within the CDAS system which is in the ArcInfo™ Exchange (*.e00) format. This plug-in is required if the user wishes to display ArcInfo™ Exchange maps.

5. Area_rep: Collection of drawing methods which allow a user to draw, modify, and specify characteristics for an area object on the CDAS map display. This plug-in is used in most applications of CDAS, and is required if area objects, such as minefields, tactical objectives, and assembly areas must be drawn or displayed.

6. C3sim_plugin: A collection of methods and local data stores that allow the user to produce a simulation of a tactical course of action for both red and blue forces. This plugin is normally used in conjunction with the Sim_Mgr plug-in.

7. Categorization: A collection of GUIs, algorithms and methods that allow a user to perform slope-based categorization of terrain data. Any area object can be categorized using this plug-in. Categorization is defined in terms of unrestricted, restricted, and severely restricted terrain for purposes of mobility of vehicles and foot soldiers.

8. Chat: A GUI which allows a user to open, close, join, and leave a chat session within the CDAS system. This function works in a manner similar to AOL Internet Messenger. This plug-in is used in conjunction with the Chat_Mgr plug-in.

9. Chat_mgr: Underlying logic which manages the CDAS chat sessions. Allows management of multiple chat sessions among CDAS systems, with multiple chat session participants.

10. COA_base: Basic services and methods that form the logic for creation of a task organization for simulation of a course of action. This allows the collection and assignment of vehicles and characteristics to a task organization, along with assignment of logistics attributes and tactical behavior. Normally used in conjunction with the COA_Org_tab, C3Sim_Plugin, and Sim_Mgr plug-ins.

11. COA_org_tab: GUI which allows the user to organize his tactical units when developing a task organization for use in a course of action simulation. Normally used in conjunction with the COA_base, C3Sim_Plugin, and Sim_Mgr plug-ins.

12. Comm_tab: GUI which allows a user to transmit and receive preformatted messages. These are broadcast message, in that they are broadcast to all CDAS systems. Using this GUI, the user can select the type of message he desires to send, then fill in various text fields, and send the message. This is used in conjunction with the Newsgroups plug-in.

13. Command_{—}1: GUI which allows the user to perform platoon command and control functions for the MRAAS. Using this tab, the user can specify the formation in which he wants the platoon to work, and also specify the methods of engagement for the platoon against target arrays.

14. Command_{—}2: GUI which allows the user to perform company command and control functions for the MRAAS. Using this tab, the user can specify the formation in which he wants the company to work, and also specify the methods of engagement for the company against target arrays.

15. Complex_rep_plugin: GUI toolbar and drawing functionality that allows the user to draw complex line and point objects such as axis of advance, linear minefields, observation posts, and supply points on the CDAS map display. This is one of the more basic plug-ins, and would normally be included in all versions of CDAS.

16. Contour: A collection of GUIs, algorithms and methods that allow a user to display and manipulate contour elevation maps using terrain data. Any area object can be displayed as a contour map using this plug-in. Contour maps provide a visualization of different elevation bands within an area or region.

17. Db_tab: a GUI in the form of a tab, which allows the user to manipulate, create, delete, hide, show, and share CDAS databases. The actual databases are managed within the CDAS core application backplane.

18. Dem_renderer: A collection of GUIs, services and functions which allow the import and display of Digital Elevation Models (DEMs) from the US Geological Service. These can be displayed on the CDAS map display.

19. Dis_core_plugin: This is a collection of translation services that allow CDAS to receive, decode, and translate basic Distributed Interactive Simulation (DIS) PDU messages from DIS simulations such as OTBSAF, ModSAF, and JCATS. The translation function of this plug-in allows CDAS to convert information received in DIS messages to data which CDAS can place into its database, and then display on the map display. CDAS can also reason about this data after translation. This is normally used with either the Dis_custom_plugin or the Dis_standard_plugin, and only if there is a requirement to receive DIS messages.

20. Dis_custom_plugin: Collection of translation services that allow CDAS to receive and transmit custom signal PDUs within the DIS environment, mainly for the purposes of controlling the fires of entities contained within the Fort Knox OTBSAF environment.

21. Dis_standard_plugin: Allows the transmission of DIS PDU messages from CDAS. Used mainly to allow a CDAS system to transmit an entity state PDU to other systems (both CDAS and DIS), which causes those systems to see the transmitter as a vehicle of a given type, such as MRAAS.

22. Dlg_renderer: A collection of GUIs, services and functions which allow the import and display of Digital Line Graphs (DLGs) from the US Geological Service. These can be displayed on the CDAS map display, and are similar in appearance to NIMA 1:50,000 scale digital maps.

23. Docked_mgr: Services that manage the docking and undocking of GUI tabs and monitors within the CDAS GUI.

24. Drawing_bar: GUI toolbar and services that allow placement of basic line, point, and area objects on the map display. Once placed, the user may modify the objects. This is usually used in conjunction with the Complex rep_plug-in and line rep Plug-in.

25. Dxf_renderer: GUI and database component which allows the user to access and cause to be displayed any digital map data within the CDAS system which is in the Drawing Exchange Format (*.dxf) format. This plug-in is required if the user wishes to display DXF maps which are produced by architectural applications such as AutoCad™.

26. Elev_plugin: GUI and services that allow tracking and display of elevation of any location on the map display. Also allows extraction of elevation of any given point on the map display for use in attributes of units and targets.

27. Email: GUI and services that allow users to send and receive email from within the CDAS application. Not currently used.

28. Engagement_bar: GUI toolbar and services that allow the user to display and manage target list and attack guidance.

29. Fca_integration: AlphaTech, Inc. plug-in that performs multi-target weapon-system pairing via auction algorithms. Results of weapon pairing are sent to CDAS as recommendations which are displayed in the Fire_tab plug-in. This plug-in can be used in lieu of the Weapon_pairing plug-in. Both perform the same function within CDAS in different manners and using different algorithms.

30. Ffr_controller: GUI elements and services that allow access to the knowledge base and other CDAS databases in order to produce representations on the map display of such items as unit physical footprints, weapon range footprints, command relationships, and density of fire footprints.

31. Fire_docked: GUI and services that allow monitoring of fire mission status. This plug-in is normally used in conjunction with the Fire_tab in order to provide a complete fire mission processing capability.

32. Fire_sim_monitor: Services that allow the receipt, translation, and sending of custom messages between CDAS and the Fort Sill FIRESIM application. Messages received from FIRESIM are translated into CDAS data objects, which can then be reasoned about and displayed on the map display.

33. Fire_tab: GUI tab and services that allow access to information concerning targets, available weapon systems, and munitions from the CDAS database, and which allow the user to select units to fire, either manually or automatically. Must be used in conjunction with the Fire_docked plug-in.

34. Forms: Provides the fill-in message forms used by the Comm_tab plug-in. Can only be used in CDAS if the Comm_tab plug-in is used.

35. Forward_observer_tab: GUI tab and services that allow a forward observer to send an automated call for fire. Interfaces to the CDAS database to allow point and click targeting from the map display. Optimized for use on palm devices.

36. Fx_app: FOX cross-platform GUI manager that manages the insertion of all plug-in GUI components into the CDAS GUI. Required for use of CDAS GUI.

37. Helper_docked: GUI and services that provide help prompts to users when various buttons are clicked on the toolbars.

38. Histograms 1 to 9: GUIs and services that monitor the CDAS database to provide histograms or trend monitoring of such things as fire missions per hour, number of database records, number of messages in queue, etc. Used mainly for debug of CDAS.

39. Icon_rep: Set of services and images that allow display of unit icons, as well as alternate icon representations on the map display. This is normally used in all versions of CDAS.

40. Layers_tab: GUI tab and services that allow filtering of the CDAS database objects which will be displayed on the map display. This plug-in, while not required for operation of CDAS, is normally used in all versions of CDAS to allow decluttering of the map display. Layer control provided by this plug-in is specific to each map display if more than one map is displayed.

41. Line_rep: services that allow for alternate representations of line objects. This plug in allows approximately 50 different types of line representations to be drawn. Normally used in conjunction with the Drawing_bar and Complex_rep plug-ins.

42. Logistics_tab: GUI tab and services that monitor the CDAS database, and allow for filtering of logistics data for presentation to the user. Services in this plug-in also allow for prediction of future logistics states of tactical entities.

43. Los: GUIs and services that allow manipulation of terrain data to display optical or weapons line of sight, as well as aerial line of sight from any designated point on the map display. If the point is a tactical entity, the services will query the CDAS knowledge base for the appropriate weapons maximum range for the weapon system, and calculate the line of sight to the maximum weapons range.

44. Map_bar: GUI and services that allow creation of new map displays, manipulation of map displays, and display of different map representations with CDAS. Normally used in all versions of CDAS, and in conjunction with the various map_builder plug-ins.

45. Map builder_ADRG: GUI and services that allow for import, geographic indexing and rendering of Arc Digitized Raster Graphics (ADRG) map images produced by NIMA. This plug-in is normally used in conjunction with the Map bar and Window_Viewport plug-ins.

46. Map_builder_CADRG: GUI and services that allow for import, geographic indexing and rendering of Compressed Arc Digitized Raster Graphics (CADRG) map images produced by NIMA. These images are available in a variety of scales, and also include satellite imagery. This plug-in is normally used in conjunction with the Map_bar and Window_Viewport plug-ins.

47. Map_builder_GSHHS: GUI and services that allow for import, geographic indexing and rendering of vector-based map GSHHS map images. This plug-in is normally used in conjunction with the Map_bar and Window_Viewport plug-ins. This plug in is required in the base version of CDAS, if one desires to use CDAS world maps.

48. Map_builder_contour: GUI and services that allow for import, geographic indexing and rendering of Digital Terrain Elevation Data (DTED) produced by NIMA. The plug-in interprets the terrain data, and creates a shaded, false 3-D image which can be displayed on the map display as a map background.

49. Mdi_viewport: multi-document interface services that allow for the creation and management of multiple map viewports within CDAS.

50. Met_tab: GUI tab and services that allow for entering and saving a ballistic or computer meteorological message into CDAS for use in technical fire control. Normally used in conjunction with the Mortar_tab plug-in. Optimized for use on palm devices.

51. Mortar_layout_tab: GUI tab and services that allow for entering and saving the locations of multiple mortar weapon systems within a platoon or battery of mortars. Normally used in conjunction with the Mortar_tab plug-in. Optimized for use on palm devices.

52. Mortar_tab: GUI tab and services that allow for performance of technical fire direction for mortars. Requires that a ballistic kernel be present for the mortar system for which fire direction is being performed. Used in conjunction with the Mortar_layout_tab and Met_tab plug-ins. Optimized for use on palm devices.

53. Network_bridge: Services which provide the capability to share synchronized databases across a network of CDAS systems. Includes capability to synchronize all CDAS systems, and to allow any CDAS to act as server for a synchronized database if the primary database server fails. This provides a self healing data network capability, such that no data is lost if a server fails.

54. Newsgroups: Services and GUI that allow a user to subscribe to various message newsgroups. Normally used in conjunction with the forms and Comm_tab plug-ins.

55. Ob_tab: GUI tab and services that allow a user to create a hypothetical enemy order of battle, including task organization, weapon systems, and other attributes which may be known about the enemy.

56. Orders: GUI tab and services that allow the ordering and display in sequence of orders assigned to any unit in CDAS. Also allows for deletion and interruption of orders. Can be used in conjunction with real world operations, or for direction of simulated units during course of action simulation.

57. Orders_bar: GUI and services which allow point and click assignment of orders to subordinate units in real world or simulation of course of action. Causes both a text message frag order and graphic to be sent to the unit given an order.

58. Path: GUI and services that allow for manipulation of terrain data and terrain analysis algorithms in order to calculate and display doctrinal mobility corridors for movement within any designated area object on the map display.

59. Planning_bar: GUI and services that allow for creation and display of planning objects such as Named and Targeted Areas of Interest, as well as other objects and functions which might be of use in developing a tactical plan.

60. Point_{—}2_point: GUI and services that allow for manipulation of terrain data and terrain analysis algorithms in order to calculate and display the fastest route between two points on the map display.

61. Point_rep: Services and images that allow for the creation and display of various point objects within the map display, such as obstacles, Operations Other Than War graphics, checkpoints, etc.

62. Profile: GUI and services that allow the creation and display of a side profile of elevation along any given line in the map display.

63. Puckster: GUI and services that allow creation and manipulation of simulation entities in order to produce a course of action which can then be simulated. Normally used in conjunction with the Sim_mgr, COA_Base, and COA_Org plug-ins.

64. Range_ring: GUI and services that allow for manipulation of terrain data and terrain analysis algorithms in order to calculate and display doctrinal time-distance mobility rings around a unit or weapon system on the map display. The net effect is to show the maximum extents to which the unit or weapon system could move to, given a certain time and terrain mobility characteristics.

65. Representation_bar: GUI and services that allow the alternative representations of tactical entities on the display. Normally entities will be displayed as bitmaps of unit icons, but the plug-in also allows symbolic, dot, box, and vehicle representations.

66. Rollup_tab: GUI and services which access the CDAS database in order to display a “rollup” of route waypoint locations and times for any given tactical unit or entity.

67. Route_bar: GUI and services, probably misnamed, which allow access to the CDAS databases and knowledge bases in order to display the weapon range fans for direct and indirect fire weapon systems.

68. Sdts_dlg_renderer: A collection of GUIs, services and functions which allow the import and display of Spatial Data Transfer Standard (STDS) format Digital Line Graphs (DLGs) from the US Geological Service. These can be displayed on the CDAS map display.

69. Segment_rep: GUI and services that allow for the creation of multi-segment linear objects on the map display. Normally used in conjunction with other drawing plug-ins such as line rep.

70. Self_info: services which gather current information about the weapon system in which the CDAS system is installed, such as location from GPS, and then broadcast this information to other CDAS systems.

71. Self_monitor: Services which monitor logistics and location information about the vehicle in which the CDAS is installed, and insert this data into the CDAS database for sharing to other systems.

72. Self_tab: GUI and services which allow interface to the CDAS database in order to provide information about the user's vehicle or weapon system in which the CDAS is installed. Typical use is to input data concerning number and type of munitions on hand for both real world and simulation of course of action where the user is participating as an entity.

73. Shp_renderer: GUI and database component which allows the user to access and cause to be displayed any digital map data within the CDAS system which is in the ArcView™ Shapefile (*.shp) format. This plug-in is required if the user wishes to display ArcView™ shapefile maps.

74. Sim_mgr: GUI and services which access simulation files and allow user to run a course of action simulation. Includes capability to manage interactive orders to blue and red subordinate units, and to perform attrition and ammunition consumption calculations for engagements during the simulation. Used with other simulation plug- ins and COA plug-ins.

75. Slope: GUI and services that allow for manipulation of terrain data and terrain analysis algorithms in order to calculate and display slopes within an area object on the map display.

76. Splash_screen: GUI and services which allow user to log in to the CDAS application.

77. Status_bar: GUI tab and services which allow access to the CDAS database and provide logistics states for all units within a task organization. The organization logistics states can be aggregated for any level from individual vehicle to the highest level in the task organization.

78. System_bar: GUI and services which provide capability to perform system-wide functions in CDAS such as redraw and object deletion.

79. Tab_mgr: Services which allow the management of all GUIs which are represented within CDAS as tabs. Allows showing or hiding of the tabs, and manages information shown in tabs.

80. Target_rep: GUI and services which allow for representation of different categories of targets such as high payoff routine, fired, preplanned, and time critical.

81. Terrain_tab: GUI and services which allow access to and manipulation of terrain data to perform a variety of terrain analysis, route planning, elevation tracking, mobility corridor, and line of sight functions.

82. Tools: GUI and services which manage the display and creation of all tabs, monitors, and toolbars within the CDAS application.

83. Unit_rep: Services and images which allow display of MIL-STD-2525 symbology for all tactical entities which the CDAS must display.

84. Unit_tips: GUI and services that allow access to the CDAS knowledge base in order to provide weapon system information about tactical units shown on the map display. Any two of approximately 40 different data categories which can be representative of a weapon system may be selected for display. Used in conjunction with the View Prop_bar plug-in

85. Units_bar: GUI and services that allow user creation of friendly, enemy, neutral, and unknown tactical units or entities and display of these entities on the map display.

86. Vehicle_bar: GUI and services that allow vehicle level functions to be performed, such as gun aiming, driving, turret rotation, etc. Must be used in conjunction with a joystick. Driving causes the self info plug-in to transmit new vehicle locations to other CDAS or DIS systems as the user drives the vehicle.

87. View prop_bar: GUI and services which provide quick reference information about any tactical unit or entity, after the data categories have been selected for display. Used in conjunction with the Unit_tips plug-in.

88. Vmap_renderer: GUI and services that allow for import, geographic indexing and rendering of Vector Map (VMAP) level 0, 1, and 2, as well as Urban Vector Map data produced by NIMA. This plug-in is normally used in conjunction with the Map_bar and Window_Viewport plug-ins.

89. Voice_tab: GUI tab and services which allow voice enabled access to the CDAS user interface. Also allows creation of voice macros to create complex strings of user interface functions which can be represented with a single voice command. Requires use of a voice recognition engine with CDAS to provide voice tokens.

90. Weapon_pairing: Alternative set of services to the fca_integration plug-in. Contains algorithms which perform multi-target, multi-weapon system pairing in order to obtain optimal target-weapon system pairing for large target arrays.

91. Weapons: GUI and services which provide weapon system level monitoring of logistics, such as ammunition on hand, fuel on hand, etc.

92. Window_viewport: GUI and services which provide the georeferenced window environment, and canvas on which maps, tactical objects, and graphics may be drawn. Required for all CDAS applications, unless map display is not required, as with the CDAS_Proxy.

93. Wizard_tab: GUI and services which perform target assessment within CDAS, and comparison of target arrays against current attack guidance. Provides advice to users for changing attack guidance when target array is not appropriate to current attack guidance.

C3Core Functionality

One purpose of C3Core is to provide a set of automated, composable tools to commanders or their staff officers for use during the planning and execution monitoring processes of battle management. Current software applications require extensive knowledge of computer science on the part of the operator, as well as extensive use of the computer keyboard for entering tactical data. C3Core is designed to allow the average operator who is assumed to possess some tactical domain expertise and basic familiarity with computer operation, to plan and execute the battle while maintaining a high degree of situational awareness. The system is aimed at the average sergeant, lieutenant or captain who may be serving as a watch officer or staff officer in a tactical operations center. When used in a networked command center environment, the application provides all system users with a Common Operational Picture (COP) via a distributed database. Each user on the tactical network can then customize the COP for his/her particular role by using a variety of reconfigurable tools.

Distributed planning is accomplished via creating a plan, sharing it with the other users on the network, and then allowing the other users to “mark up” the shared plan. This is a real-time interactive distributed planning capability which allows multiple role players to simultaneously build and alter a tactical plan, similar to using multiple plan developers around a wall-mounted whiteboard. In this case, the whiteboard is the digital map display of the application. The application also includes a special Whiteboard function which allows users to perform all of the distributed and shared planning functions, but which also synchronizes their map views, such that all participants look at the same view of the map.

Many of the products which result from the decision support tools can be exported to other command and control systems, and used within those applications as overlays or text files. The following are examples of planning products that can be exported:

DTED, VITD, or User-generated Terrain Analysis Overlays

NAI Overlay

TAI Overlay

Mobility Corridor Overlay

Range Rings Overlay

Line of Sight Overlay

Range to Yellow, Red, and Black Fuel Status for a unit (Overlay)

Unit Routes Overlay or Text file listing of waypoints

Artillery Targets Overlay

Maneuver Graphics Overlay

Synchronization Matrix (File readable by MS Access or Excel)

Decision Support Matrix (File readable by MS Access or Excel)

Bitmap picture of the Planning Map

Alerts (sent by email to various users)

The C3Core provides functionality in two distinct roles: the first, during the planning process, is to allow the user to “drag and drop” planning objects (units, maneuver graphics, etc) onto a map display in order to develop a plan. Each planning object on the screen can be queried and described in terms of attributes such as time, status and role. These planning objects are then saved as a plan against which the current situation is checked during the execution of the plan. When the plan is being executed, any events which correspond to an alert match results in alerts to the user. The user alerts are in the form of “stickies” which are red, yellow, or light blue text explanations of the alert. The second role of the viewer is to provide situational awareness as real world events occur.

During the planning phase, the user may also perform several Intelligence Preparation of the Battlefield (IPB) processes in order to develop a decision support template which includes Named Areas of Interest (NAIs), Targeted Areas of Interest (TAls), and Decision Points (DPs). The NAIs and TAIs can be placed on the map by the user, and attributes for activation set for them. The NAIs and TAIs can also be autogenerated by the computer if desired. Triggering conditions for NAIs/TAIs, and decisions to be considered when an NAI or TAI is activated can also be entered during the planning phase.

Additionally, there are various terrain analysis functions which can be performed by the software, including the ability to generate mobility analyses, mobility corridors, choke points, etc. These functions are used to support the IPB process, as well as to perform various other special functions such as route planning, line of sight calculations, etc.

When information is received during runtime or realtime by the application, the application parses the information into a form recognizable by the software, and then checks the information against the current plan being executed in order to determine whether any critical information requirements are matched by the information received. An artificial intelligence software module performs this checking operation. If there is no match or partial match, the information is simply stored, and any appropriate updates to unit positions, unit statuses, etc., are performed unobtrusively on the COP display. If there is a match, the application generates an alert to the screen, and an alert message which is placed a) in an alert “sticky,” b) in the status tab message window next to the situational display, and c) in a small message window which is contained in unit status windows which are displayed if units causing the alerts are queried. The alert is also broadcast via electronic mail to those users, which have requested notification of alerts.

Critical information alerts are classified into one of three general types: housekeeping, trigger, and alarm. A housekeeping information requirement generally denotes information of interest to the commander or staff officer which indicates information which affects the status of friendly forces. An example would be a subordinate unit which reports that it's ammunition status is critical. A trigger information requirement is generally phrased as “Let me know when or if event A, B, or C happens.” An example of this would be, “Let me know if enemy unit X attacks across the river, but not if they are only moving out of the way of the river flood stage.” Finally, an alarm information requirement is any information that immediately or in the near future threatens the force or the current scheme of maneuver. An example of this type of information requirement would be identification of an enemy battalion-sized combat unit that was not anticipated in the planning for the current scheme of maneuver.

All alerts are displayed on the screen in the form of a “sticky,” which is a concise text explanation of the alert, with a red, yellow, or blue background. Alarm information requirements matches are displayed as red stickies, trigger matches as yellow stickies, and housekeeping matches as light blue (or cyan) stickies. Currently, there are no housekeeping alerting functions available in this build of the software. The sticky overlays the screen object associated with the alert (unit, NAI, etc.) and provides a one-line description of the alert. The user can then query the object described in the sticky alert for details of the alert.

General C3Core Features:

Look, feel and operation of the user interface is very similar to Windows 95/98/NT

All objects are automatically assigned to the appropriate overlay layer.

Multi-role capability provided by different user-definable defaults and preferences for different tools.

Ability to assign and show object relationships.

Ability to query objects on the screen.

Ability to pan and zoom base map .

Ability to create multiple map displays with separate overlay control for each map.

Coordinate and distance tracking of the mouse cursor.

Designed for Joint Task Force operations, not simply army ground tactical operations.

Designed for use at different echelons from individual vehicle to Brigade HQ in infantry, armor, artillery, and other domains.

C3Core Planning Features:

Import and build task organizations and orders of battle.

Drag and Drop units from tool bar or Task Organization onto the map and reposition.

Assignment of attributes and tactical relations to objects.

Ability to build and modify task organizations graphically.

Ability to draw plan battle graphics.

Ability to export and import and share plans between systems using F2DSS

Ability to export planning and decision support products to other systems

Distributed planning capability.

Tactical Plan is not simply a drawing; it retains all object attributes and reasoning behind the plan.

Numerous terrain and mobility analysis functions.

Storage and retrieval of multiple plans

C3Core Execution Features:

Auto refresh of display.

Tracks objects as they are moved or updated by messages.

Allows objects to be queried directly for status attributes.

Allows the display of historical positions.

Allows the display of projected or planned unit positions.

Shows critical information alert matches matches in the form of “sticky alerts. Robust capability to create, edit, view, save, send and receive a variety of tactical messages between networked F2DSS systems.

Manual target track management

Permissive or restrictive coordination of fires

Automated or manual target-weapon system pairing for target attack

Other C3Core Features:

text chat

internet messaging

e-mail

flexible, composable planning and execution toolsets that can be tailored for any staff or command position from squad leader to division commander

capability to support at least 100 role-players

Real-time, graphical and textual orders generation and sending capability

Unit-to-unit or vehicle-to-vehicle combat simulation in COA tool

Ability to show red, blue, or ground truth based on user's side or alliance, which supports fog of war concept

Ability to command simulation units or entities to perform actions on-the-fly

Defined behavior for autonomous tactical simulation entities and units to include:

Self defense

Movement

Following

Searching or scouting

Maintaining contact

Attack by direct fire

Attack by indirect fire

Resupply behavior

Tactical formation behavior

Ability to calculate and save battle results and logistics (mainly ammunition) use

Ability to develop graphical overlays using MIL-STD-2525d tactical graphics

Ability to build and task organize units

Ability to support multiple map/display views on single workstation, i.e., planning view and maneuver view.

Ability to support common operational picture, common logistics picture, and common fire support picture

Ability to conduct real-time, network-based collaborative planning

Ability to share and save all tactical maneuver and intelligence overlays, fire support overlays, and attack guidance

Ability to interface to any DIS-based simulation such as OTBSAF, MODSAF, FIRESIM, etc.

Formation control which can be changed in real time

Extensive weapon system knowledge base (based on Janes) containing mobility, protection, and armament attributes for most of the USMC vehicles listed in the SOW, most US Army vehicles, most foreign power vehicles, and many aircraft.

Ability to import and display all NIMA map products, to include ADRG, CADRG, 5 m and 10 m Controlled Image Base Satellite imagery, Digital Terrain Elevation Data, Vector Map Levels 0-2, Urban Vector Map

Ability to import and display commercial and US Geographical Service map products for use in the game, to include ArcView™ Shape Files, ArcInfo Digital Information Exchange files, AutoCad Drawing Exchange Format (DXF) engineering drawings, USGS Digital Line Graphs, and USGS files in National Imagery Transmission Format.

Ability to perform terrain analysis functions to support Intelligence Preparation of the Battlefield (IPB) to include:

Ground and Aerial Line of Sight

Mobility and Combined Obstacle Overlay

Automated or Manual Generation of Named and Targeted Areas of Interest (NAIs and TAIs)

Display of Mobility Corridors for different tactical echelons

Time versus mobility estimations for travel distances

Calculations of fastest routes through terrain

Ability to include user-defined areas of limited mobility terrain (such as minefields) in terrain analysis calculations

Real time monitoring and display of logistics status for any tactical entity (Classes I-IX, maintenance, etc.)

Prediction of critical supply shortages based on rates of expenditure

Ability to direct or order logistics units to resupply tactical units with specific quantities and types of supply.

Representation within unit attributes database of all unit characteristics except MOPP level and fatigue, which can be easily added.

Representation of all mobility types.

Graphical representation of unit “footprints” to represent the area the unit occupies on the ground.

Ability to create initial stockage levels for tactical and/or support units

Ph and Pk based attrition combat modeling for course of action wargaming.

Embodiments of the invention include a preferably re-usable architecture which not only can contain numerous command and control components which can be reused, but which also may contain a repository of components which can be used, along with the core backplane and databases to tailor various command and control applications for multiple uses. [C3Core]. This architecture is a computer-based system for modeling, architecting, designing and implementing a Command and Control system from re-usable components to assist either military or civilian personnel in performing predefined tasks. The architecture is used for both military and Homeland Security In a preferred embodiment, the architecture is composed of:

a. A paradigm for modeling and simulation of either synthetic or human operators who perform a sequence of operations that allow pre-defined tasks to be built and represented within the system.

b. A repository of existing components composed of algorithms, encoded processes, and data flows that can be selected by users or developers in order to perform well-defined tasks.

c. A component selection and management system that supports user or developer selection, reordering, and composition of repository components into clusters of functionality in order to produce different domain-specific or domain-neutral applications for use in the laboratory, classroom, or field.

d. A framework for extending or limiting applications built from repository components without the need to recompose or rebuild said applications.

e. A well defined implementation interface that allows new components to be added to the component repository for use in applications; and for existing components to be replaced, without affecting the operation of other components or of the framework in d above.

The command and control system can contain a collection of services, algorithms, methods and representations, within a component, that allow a user to perform categorization and classification of terrain data for mobility, countermobility, route planning, and visibility calculations. Such a system is particularly applicable to use in military planning and command and control, and for Homeland Security Operations. Unless specifically stated, the algorithms are used for both military command and control and for Homeland Security operations.

Embodiments of the invention may include a unique terrain classification algorithm that analyzes Vector Map data produced by the National Imagery and Mapping Agency (NIMA) in order to produce an estimated vehicle speed over any given terrain. (As used herein, “vehicle” may mean a person or group of people, and “terrain” includes land and/or water.) This algorithm uses the characteristics of any given vehicle, characteristics of the Vector Map terrain features, and a rank ordering system of the effects of terrain features on mobility to determine vehicle speed over multiple terrain types. The uniqueness of the rank ordering system in this algorithm is that it does not use the published terrain feature attributes which are specified for NIMA Vector Map data. The attributes for all vector map data have been left blank by NIMA, and are useless in terrain classification. The rank ordering system of terrain features in vector map data bypasses the attributes of the features and directly operates on the relative impact of any given type of terrain feature on mobility, as compared to the impact of other terrain feature types on mobility. This algorithm is also used on USGS and US Census Bureau vector data for Homeland Security mobility planning for emergency response

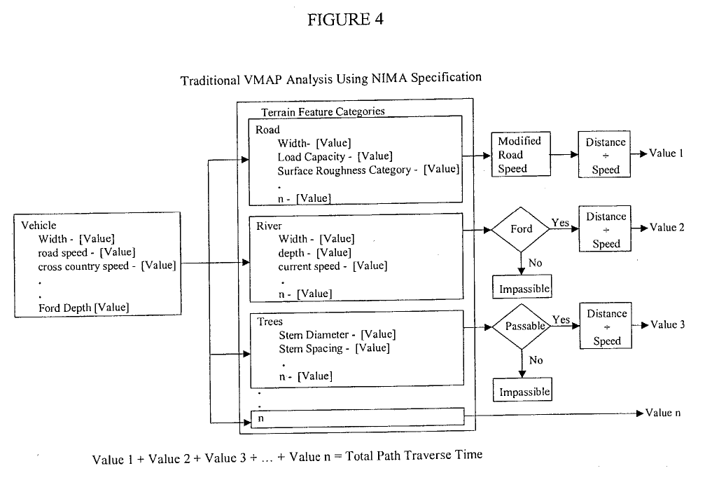

NIMA VMAP specifies data attributes, each with a value, defining terrain feature categories. When these data attributes are present, an algorithm may be developed that uses certain vehicle characteristics such as road and cross-country speed, vehicle width, and fording depth, and then applies these characteristics against the data attributes in each feature to determine a speed modification based on the attributes. The speed modification is then applied to the distance that the vehicle must traverse across the terrain feature in order to obtain a time value. The time values are summed to obtain a total transit time for all features along a route. To find the fastest route between two points, the algorithm creates a raster of values for the area containing the points. The path which obtains the lowest accumulated value can then be selected automatically or manually. A prior art algorithm to produce such values is summarized in FIG. 4.

This method is valid, and provides valid results if Terrain Feature Category Attributes have actual values as prescribed in the NIMA specification for Vector Map feature data. However, if the attributes, such as Road Width and Load Capacity are empty, as is the case with all NIMA VMAP data currently, the method fails and no valid Total Path Traverse Time can be calculated. The VMAP features can be displayed, but not reasoned about for mobility.

As shown in the FIG. 4 subtext, if attribute data is missing for the terrain features, no calculation can be made and the algorithm fails. Since all NIMA VMAP data is currently produced without the attribute data in contravention of the VMAP specification, no calculations can be made about the mobility characteristics of the terrain features contained in a VMAP data set. To overcome this limitation of the data, embodiments of the invention include a means to assign relative mobility modifier values to each terrain feature category which can affect the ground mobility of a vehicle. The same vehicle characteristics are used as in the previously described algorithm. However, instead of using data attributes of the VMAP data, a relative mobility value is assigned to each type terrain feature. This value is based on a number of factors. First, different map scales include different types of features. For example, VMAP level 0 is produced a scale of 1:1,000,000. If one compares the vector feature data at this scale to an actual paper map of the same area, one will discover that only very large terrain features such as wide, deep rivers and major highways will be depicted. On VMAP level 2 maps, which are produced at a 1:50,000 scale, nearly every hiking path, stream, and house is depicted. Therefore, the same type of terrain feature may have a different value, based on the scale of the map. To illustrate, on a VMAP level 0 map, any river must be treated as unfordable and unswimmable by vehicles. One may only cross the river on a bridge. On a VMAP level 2 map, a river may be both fordable and swimmable.

Second, only some of the terrain features have an effect on mobility. Some of the feature types have the effect of increasing mobility, and some have the effect of decreasing mobility. Primary features that increase mobility are roads, grassland areas, runways, etc. Primary features that decrease mobility are built up areas, swamps, wooded areas, rivers, lakes, inland waterways, and similar features. First, each terrain feature type that affects mobility has been given a rank ordering in terms of its importance to mobility, and multiplier that is applied to the vehicle mobility characteristics. An example is shown below.

| Feature | Rank | Multiplier |
|---|---|---|
| Road | 1 | 1.5 |
| Bridge | 2 | 1.2 |
| Grassland | 3 | 1.0 |
| Forest | 4 | 0.5 |
| Swamp | 5 | 0.25 |
| River | 6 | 0.01 |

The rank ordering is used to determine the relative importance of the feature as compared to other features in a given area. For example, if both a river and a bridge are contained in the same area, the bridge has higher priority and is used in the calculation, and the river is excluded. Only the bridge multiplier for mobility is used. If a road and a forest are contained in the same area, the road is used, and the forest is ignored.

The multiplier is used to increase or decrease the estimated speed of travel of the vehicle over the particular terrain feature. If the vehicle, for instance an M1 tank, has a normal cross-country speed of 40 km/hour, then its road speed would be 60 km/hour. Its speed through forest areas would be 20 km/hour.

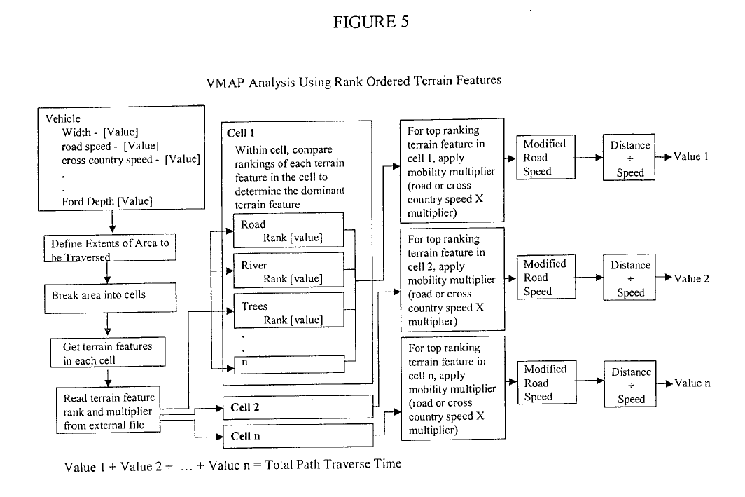

This algorithm compensates for the fact that NIMA VMAP data has no data attributes associated with it. The user of the algorithm may change the rank ordering and multipliers, to account for his own knowledge of terrain within a given area. This is possible, since the values and multipliers are kept external to the algorithm within a text file which can be edited by a user. FIG. 5 shows the steps in the algorithm calculations for an illustrative embodiment of the invention.

This method is valid, and provides correct results if Terrain Feature Category Attributes prescribed in the NIMA specification for Vector Map feature data have no values entered. The VMAP features can be both displayed and reasoned about for mobility. Since rank order and multipliers for terrain features are kept in an external data file, users may change the values based on their particular situation or knowledge.

A slope-based terrain categorization algorithm which calculates slopes that correspond to different mobility categories may also be included in the present invention. Mobility categories are defined in terms of unrestricted, restricted, and severely restricted terrain for purposes of mobility of vehicles and foot soldiers. The algorithms used for this categorization are unique in that after raw slopes have been determined, polygons representing the severely restricted and restricted mobility categories are generated. These polygons are then “grown” outward from the edges using a stepping algorithm. This is done to ensure that small areas of restricted or severely restricted terrain are absorbed into larger areas if in close proximity, or to show where these types of terrain exist in isolation. The polygons are then “shrunk” inward from the edges approximately half the distance that they were originally grown, to reduce the overall number of polygons to be used in mobility calculations. This leads to very accurate terrain categorization for slope mobility when compared to use of centroid-based algorithms which are typically used in most if not all other terrain classification systems.

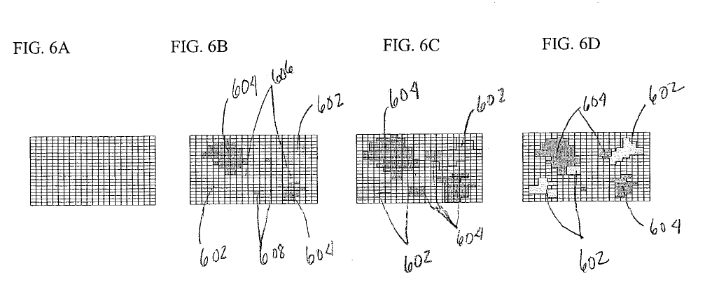

An illustrative slope mobility algorithm is depicted in FIG. 6 and is described as follows:

Step 1 shows the extraction of elevation values from a raster of values at equidistant geographic postings. Postings are typically 100 or 30 meters apart. After extraction, slope is calculated at each posting, in relation to the 8 postings which surround each individual posting.

Step 2 assigns a relative mobility value, such as Slow Go or No Go, to each square formed by four postings. In the FIG. 6 below, this results in four slow go (602) and four no go (604) polygons.

Step 3 grows the polygons outward n number of steps to absorb isolated instances of no go (606) or slow go (608) terrain that are close to larger areas of slow go (602) or no go (604).

Step 4 shrinks the expanded polygons by n−2 steps which reduces the overall number of polygons to be used in mobility calculations. It also smoothes the edges of the larger polygons in large sample sets.

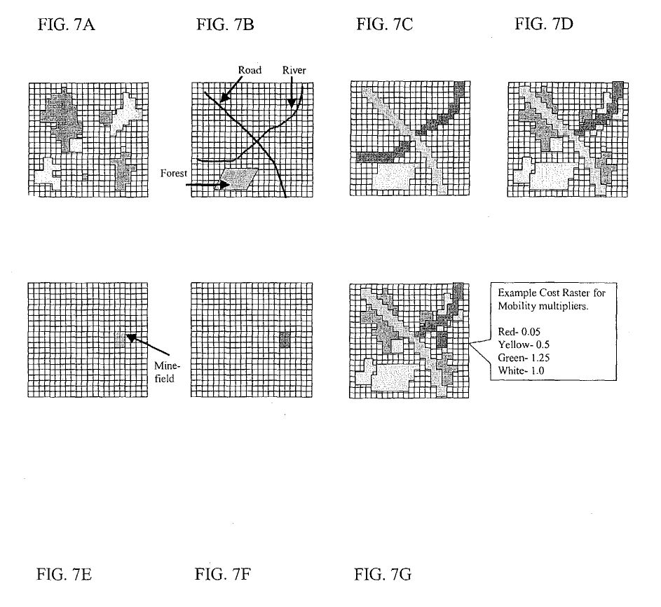

In particular embodiments of the invention, the terrain classification algorithm and slope-based terrain categorization algorithm may be implemented together. This is shown in FIGS. 7A-G. A terrain classification and fusion algorithm fuses information from the two algorithms, optionally factors in other three-dimensional terrain features created by the user which may not be represented within a NIMA vector map dataset, and produces a cumulative estimated vehicle speed over the terrain.

Following is an illustrative embodiment of a fusion algorithm as depicted in FIGS. 7A-G:

Step 1. Perform slope mobility analysis and determine areas of Slow Go and No Go terrain: or other relative mobility values.

Step 2a. Extract and compute mobility values for VMAP terrain features.

Step 2b. Convert VMAP mobility values to High Mobility, Slow Go, No Go, or Go or other relative mobility values.

Step 3. Fuse results of steps 1 and 2.b. to obtain slope mobility and terrain feature mobility overlay.

Step 4. Obtain terrain or battlefield features that affect mobility, which were created by the user.

Step 5. Convert user-defined features to Slow Go, No Go, Go, or High Mobility or other relative mobility values.

Step 6. Fuse results of steps 3 and 5 to create combined mobility map or raster. Cost factors can be assigned to each cell based on default rates for relative values; or with VMAP multipliers where possible. End results is a cost raster of mobility multipliers for each cell which are then turned into vehicle speeds after the particular vehicle characteristics are defined.

In a further embodiment of the invention, a flood algorithm that uses the terrain and fusion algorithms to estimate the maximum distance and location that any defined vehicle can reach in all directions from a single starting point within a specified time interval. The net effect is to show the maximum extents to which the unit, emergency response vehicle, or weapon system could move to, given a certain time and terrain mobility characteristics.

The following are input (as used herein, “input” means by user or preprogrammed unless otherwise designated): a world point, max duration, movement rates and UDT set. The algorithm creates a matrix with the given world point as the center describing the time needed to reach each point.

Range ring analysis is formed on one algorithm that utilizes two algorithms to perform its calculations. It uses a cost function and a result replacement function. The cost function determines the time needed to travel from point A to point B. The result replacement function is needed to allow modification of the results. The path algorithm returns two sets of data, but range rings only needs the time matrix as output. The other set of data is used in another analysis. The path algorithm may also be told externally when to stop computing the result sets. The end condition that range rings uses is a max duration. Comparing the current cost with the max duration checks the condition. Range ring analysis does not require an immediate exit of the algorithm if the condition is met.

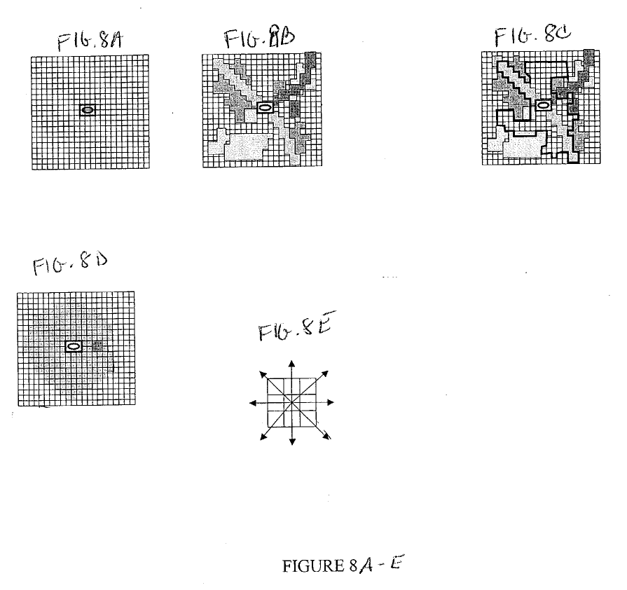

Following is an illustrative flood algorithm as depicted in FIGS. 8A-C:

Step 1. Select vehicle, get vehicle speed characteristics, such as for highway and cross country mobility from external data store. Input maximum time desired for mobility calculation. Place vehicle at a location where terrain data exists.

Step 2. Generate cost raster of mobility multipliers for each cell, out to a specified distance, such as of twice maximum distance that vehicle can travel in specified time.

Step 3. Starting from the location of vehicle, and moving outward, algorithm multiples cost raster mobility multiplier times vehicle speed for cross country or road, in each cell. Algorithm then determines, based on the adjusted vehicle rate for each cell, the time required to transit each cell. Each cell is assigned the resultant time value. Again stepping outward from the center location of the vehicle, transit times for each of the 8 cells surrounding the original cell are added to the transit time for the center cell. The results are added and kept separately for each cell. Then, for each of the 8 cells, each of the cells' 8 neighbor cells' transit times are added to the original 8 results, and so on. The final result is a boundary line, which represents the maximum distance that the vehicle can travel through various terrain types, in the originally designated maximum time.

FIG. 8D provides an Example of how flooding algorithm will “flood” around an obstacle when creating range ring. Rather than leaving a “shadow of untraversed cells, the eight-direction stepping from each successive cell ensures that the possible transit time/space reaches around the obstacle.

FIG. 8E show how eight-direction stepping from each cell ensures all contiguous cells are traversed. If the cell has been traversed already during the calculation along a given path, it is eliminated from the summation of time, as retraversing a cell is not allowed in the algorithm.

The output of the terrain and fusion algorithm may also be used in conjunction with any of the following algorithms.

1) A route planning algorithm that defines the fastest route between two points within a geographical area.

2) An algorithm that combined with doctrinal knowledge of tactical widths of combat unit formations, calculates and displays doctrinal mobility corridors for movement within any designated geographical area.

3) An intervisibility algorithm that detects visible versus non-visible locations from a fixed vantage point on the ground or in the air.

A more detailed description of each of these algorithms will now be provided.

The following is a description of an illustrative embodiment of the route planning algorithm. A world point, end condition and cost function are specified. From this, a time matrix and parent matrix are generated. During the process, cost-to-point values are temporarily stored.

A point location of the center is selected, which is the given world point, with a cost of zero. The cost to get from the current point and its eight neighbors is then computed. The costs based on the current cost are adjusted. The result set for each neighbor is then adjusted based on result replacement. The cost to get from the current point and the sixteen neighbors that are one step away is computed. The costs based on the current cost are then adjusted. The result set for these neighbors is adjusted based on result replacement. It is determined if the end condition is met for the sixteen neighbors. If it is met and it is desired to stop processing, processing is stopped. Otherwise if the end condition is not met, the new cost for each point is stored only if result replacement occurred.

A further embodiment of the invention considers a world point, a destination world point, movement rates, and optimally a UDT set to obtain an array of waypoints. This algorithm can use the same path algorithm used by the range ring analysis. The end condition, however, is different. The point-to-point end condition is, “if the current test point is the destination then stop adding to the heap.” The waypoint array is calculated by transversing from the destination point in the parentage matrix back to the source point.

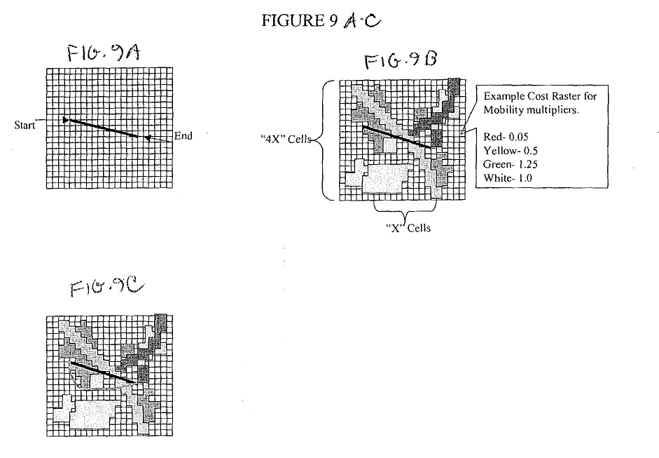

FIG. 9 shows the stops of an illustrative algorithm to determine a fastest path between two points.

Step 1. Select vehicle, get vehicle speed characteristics for highway and cross country mobility from external data store. Input starting point and ending point to perform fastest route calculation.

Step 2. Calculate center point of line between start point and end point. Calculate number of cells along line between start point and end point (let result equal X). From center point of line, generate cost raster of mobility multipliers for each cell, out to a distance of twice the number of cells that lie along the line from start to end point.

Step 3. Using an eight-direction stepping algorithm, determine time required to traverse each cell. This can be done from the start point to end point or done from start and end point simultaneously to reduce algorithm execution time. Cells between start and end which result in shortest time form waypoints along fastest path.

A more detailed description of the mobility corridor generation algorithm is now described. The algorithm may perform corridor analysis upon a user selectable area. The Corridor analysis can be configured to use both DTED and VMAP data as the basis for categorization data. The corridor analysis is capable of identifying mobility corridors through the terrain, identify corridor lengths, minimum width and location, maximum width and location, corridor junctions and classify the corridor by echelon based upon doctrinal sizes.

Categorization data from a fusion algorithm, such as was previously described, can be utilized for this analysis. In an illustrative embodiment, first the raw categorization data is converted into “colored” data which is the process of producing a matrix of equal size in which each type of categorization ( i.e. Unrestricted, Restricted, . . . ) is represented by a single value or color. This preprocessing provides the initial input to the corridor analysis. The corridor analysis utilizes the concept of geometric manipulation. This is primarily in the form of polygon augmentation algorithms which either grow or shrink polygons. The overall effect is that any terrain which is restricted to some degree continues to grow until it attempts to merge with another area. At this point, the growth along that plane is halted which results in the identification of centroids between all areas under analysis. It is these paths which help to define the corridors.

The analysis can be broken down into five distinct phases. Each of the phases is discussed below:

Noise Filtering

The raw colorized categorization data often includes small isolated areas of restricted terrain within unrestricted terrain which are considered to be noise in the data. Under actual maneuvers, these isolated area would be easily avoided and during the analysis phase, can be safely ignored. Either utilizing a default value or a user specified override, all object which are smaller than some given size are removed from the analysis data. This is performed by shrinking all polygons indiscriminately some distance. Since the analysis data is in the form of a matrix, this typically is performed by shrinking all polygons some number of iterations which effectively reduces them by some distance. Any object which is larger than the twice the distance shrunk will remain in the data, otherwise it will be removed. In order to restore the larger polygons back to original size and configuration, an indiscriminate grow is performed for the same distance or number of iterations as the noise removing shrink. At this point in the analysis, all objects which are below some user defined threshold have been removed from the data.

Directional Constraints

The algorithm is capable of producing either a directional or non-directional path analysis. A directional analysis requires that the user supply either one or two directions of travel to the algorithm. These are referred to as an In direction and an Out direction. When the user only provides one direction it is assumed to be the In direction and the Out direction is 180 degrees away from the In direction. In this case, the assumption is that there will be a straight traversal through the analysis area. When the user specifies two directions, the implication is that the object will perform some turning maneuver within the analysis area. In the case of a constrained maneuver, the analysis area is constrained perpendicular to the direction of travel with an impossible categorization. This effectively prevents any path from leaving the analysis area which is perpendicular to the direction of travel. When an unconstrained analysis is performed, paths may enter or leave in any direction of the analysis area. Clever use of this constraint can produce various different analyses which meet a more specific need. Below three different use of the constraints will be explained.

Unconstrained

This would typically be utilized when the analysis area is a Drop Zone or a Pickup Zone for example. The center of the analysis would be placed upon the particular zone and all viable path radiating from this point would be evaluated.

Non Turning Maneuver

In this scenario, it is assumed the analysis area lies directly in a straight line path from some source to some destination. This type of analysis is the most commonly one utilized for general purposes. All paths will enter and exit the analysis area roughly parallel to the specified direction of travel.

Turning Maneuver

This type of constraint is most effectively utilized when the analysis area is not directly in a straight line path from the source to the destination. This typically occurs when one force it attempting to shape the other force into some configuration. Another typical use is when a the analysis area is placed upon an objective which the force being modeled has a follow on mission whose direction is not the same as the approach. In this case, constraints would be placed in all mutually exclusive areas which are perpendicular to the directions of travel.

Path Rejection

The corridor algorithm is capable of effectively rejecting mobility corridors which are below a specified threshold. For example, if a corridor analysis is being performed to support a Battalion sized operation, smaller Platoon or Squad sized corridors do not play a decisive role during the analysis and should be rejected. To accomplish the removal of small paths, an indiscriminate polygon grow occurs which is smaller than ½ the desired path width. Depending upon the size of the analysis area, minimum doctrinal corridor widths are embedded into an externally read data store which are used as defaults without a user override. For example, the larger the analysis area, the implied default assumption is that the analysis is to support a larger operation and larger minimum corridors are rejected.

After this phase of the analysis, all terrain categorization objects closer than some specified distance apart are fused together, thus removing small unwanted paths. The next phase of the analysis deals with the identification of the mobility corridor centers.

Path Creation

After all of the noise and small paths have been removed from the analysis data, the next phase deals with the creation of the paths between terrain obstacles. There are two type of grow routines which are utilized in the algorithm: Indiscriminate growing and Discriminate growing. When a polygon (which represents a terrain categorization) is grown indiscriminately, separate polygons can fuse into one contiguous object. This is the ideal behavior required to remove unwanted paths. Discriminate growing, is the process where two polygons will grow towards one and another, though will not fuse. This leave a small gap between them which can later be identified as a potential path.

During the Path Creation phase of the analysis, all remaining polygons within the analysis are uniformly discriminatory grown together until all growth has terminated. This leaves only small gaps between all categorization objects. Any path which happened to form due to the shape of a single polygon will form what is called a cup. A cup is a feature in which a path terminates or could be thought of as a path that leads nowhere. The discriminate grow algorithm recognizes this condition and effectively removes these paths since they are not tactically viable.

Path Identification

After all of the polygons have been “grown” together, there exist small gaps between them that represent the paths that are centered between the original polygons. These paths represent the mobility corridors. During the path identification phase of the analysis, three subroutines are utilized to identify junctions, paths and corridor widths. All of this information is stored which allows for further processing outside the scope of this analysis.

Junction Identification

This subroutine scans the analysis data and identifies points in which different paths either join, split or are on the boundary of the analysis area. These points are retained and will be utilized latter at the “nodes” in a typical shortest path algorithm. As a side process, these junctions represent potential areas for NAI's (Named Areas of Interest) since it is at these points a force will typically follow one path over another or split. These types of maneuvers are of great interest to the opposing force.

Path Identification

This subroutine “walks” along the path which has been formed during the grow process and is able to identify the exact path. During this walk, the points found along the path are retained as well as the overall length of the path. This length is typically utilized as a cost factor during a shortest or least cost analysis. The path walking also identifies which junctions the path is associated with and forms an edge between nodes for a higher level path analysis.

Corridor Widths

During the grow process, the iteration number is stored for when a cell is converted from un-grown to grown during the polygon expansion. When analyzing the width of a corridor along some path, the adjacent grown cells provide a clue to the width of the corridor. For example, while walking a path, if the cell on the left was grown during iteration 4 and the cell on the right was grown during iteration 5 then the minimum distance between two original terrain features at this point is 4+5=9 units. By knowing the size of the cell, a path width can be derived for every point along any paths. Two additional locations are noted along a path which represents the maximum and minimum path width identified. The minimum path width can be utilized during latter analysis to identify potential TAIs (Targeted Areas of Interest) or for the placement of an obstacle. In general this minimum location identifies the choke points along the path. It also helps to classify the path for corridor echelon classification.

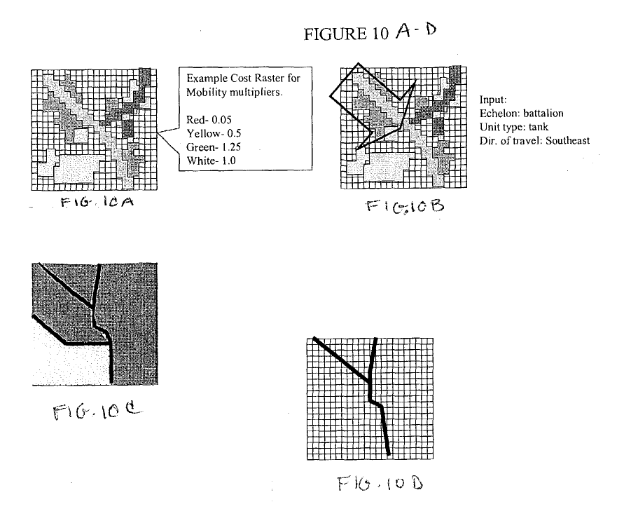

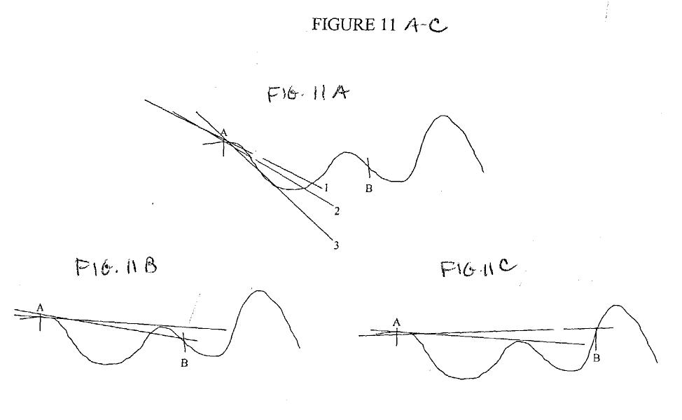

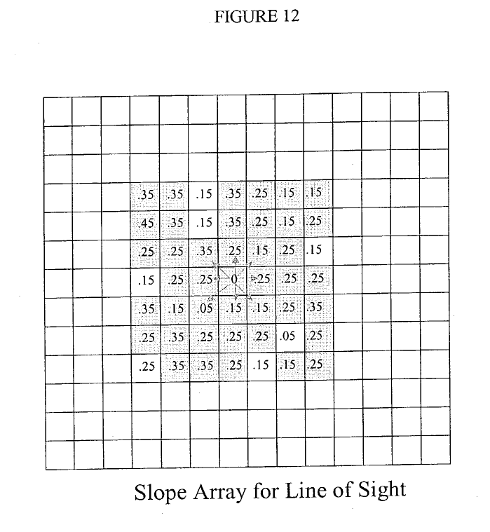

FIG. 10 depicts an illustrative embodiment of a mobility corridor algorithm. The algorithm contains the following steps:

Step 1. Start with fused terrain and slope results to create combined mobility map with polygons of relative mobility values, such as Slow Go and No Go terrain.

Step 2. Input from user the echelon (battalion, company, etc.) for which to calculate mobility corridors. Input from user the type of unit (armor, mechanized infantry, etc.) for which to calculate the mobility corridors and extract unit tactical formation width from external datastore. Input from user of direction of travel for which to calculate mobility corridors.

Step 3. Slow Go and No Grow polygons grown outward until they meet. Points where polygons meet form points along a path. Width at each point is retained during growth process

Step 4. Eliminate paths smaller than battalion width. Result is set of battalion-size mobility corridors for tank unit.

The intervisibility algorithm will now be described in additional detail.

The algorithm provides a line of sight (LOS) analysis that answers the basic question: what can be seen from this point?

A world point, sensor height, and sensor range are specified. From this, a matrix of AGL values defining the necessary target height for visual line of sight with the sensor as the center point of the matrix is generated. The process includes calculating elevations for LOS using, for example, a digital terrain elevation data (DTED) elevation interpolation method.

The base case for line of sight is, “can point A see point B,” where a point is defined as a spot in the air some number of meters above ground level (AGL) some where on the globe [AGL, world point]. The general case is, “given a point A at some (AGL, world point), what is the AGL needed for any given point around A needed in order for a target to be visible from A.”

FIGS. 9A-C depict steps in an illustrative method to determine if point B is visible from vantage point A. The process involves calculating a plurality of slopes as shown in FIG. 9A. An initial slope of zero is input. A point A₁, an incremental distance along the ground from vantage point A toward point, B is designated. The slope of a line connecting vantage point A to point A₁ is calculated. This slope is saved. Point A₂ is designated an incremental distance from point A₁. The slope of a line connecting vantage point A to point A₂ is calculated. The greater of the slope of line AA₂ and the slope of line AA₁, is saved, and the lesser of the slopes is removed. This process is repeated for incremental points until a predetermined distance from point B is reached, such as one increment. If the last saved slope is greater than a slope of a line from vantage point A to point B, as depicted in FIG. 9B, then point B is not visible from vantage point A. If the last saved slope is less than or equal to a slope of the line from vantage point A to point B, as depicted in FIG. 9C, then point B is visible from vantage point A. In a preferred embodiment increments are 30 meters.

The general case can be solved in a similar manner by storing the slope as an array. The array represents the current slope of viewing in a particular direction. The result matrix can then correspond to the AGL of the point visible on the slope for the direction from point A. In an illustrative embodiment, each cell will correspond to 30×30 meters of data to provide quick and generally accurate results for the given DTED data. To begin, an array is selected where the slopes represent staring at the ground. Since the data will be stored in an array, the slope array will contain eight points representing the eight neighbors of point A. The slope from point A to the ground of the eight neighbors is calculated. The slope array values are replaced as needed and as done in the base case. The slope array is expanded, preferably to twice its size, to allow for the size of the next ring of data. This expansion requires moving the values within the array to correspond to the new lines of sight that are being examined. After expansion of the slope array, slope calculation is repeated, checks are replaced, and slope array expansion again. The process is repeated until the distance along the lines of sight are all greater than the desired sensor range. This algorithm can be used with user-defined terrain data such as buildings. If the user defines buildings as terrain data with x, y locations for each corner and with z values for height, the raster of elevation values extracted from DTED data is altered by adding the building height (or other object height) at the x, y locations. The algorithm then performs on the changed raster of elevation values. The same procedure can be performed on VMAP data which might include buildings, towers, trees, walls, and other similar features. The user assigns a height to each of the features or classes of features, the elevation raster is altered, and then the algorithm performs on the altered elevation raster.

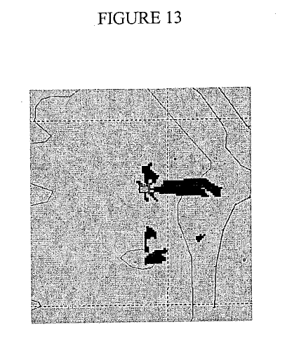

FIG. 13 shows the result of a circular line of sight calculation using the described algorithm operating on a raster of elevation values. The line of sight was calculated out to a distance of 4,000 meters for the vehicle located in the center of the picture. Shaded areas indicate the areas which can be seen from the vehicle location.

Yet another embodiment of the invention includes a DTED Point Evaluation Interpolation or analysis. The purpose is to allow interpretation of gridded Digital Terrain Elevation Data (DTED) from NIMA as continuous data. By interpolating within each of the DTED data matrix cells, an approximation of the true elevation can be calculated that takes into account the fact that the earth is not a collection of 100 m×100 m cubes.

A world point is selected. The algorithm generates an integer value describing the height at that location.

There are multiple sections to DTED point elevation interpolation. The first steps are the same as in the DTED Point Raw Elevation Extraction. The last step, however, is different.

By inputting a grid location and DTED data cell, an integer value describing the height at that location can be generated.

The DTED data can be interpreted to represent a grid. The grid starts in the northwest corner of the DTED cell and extends to one cell below and to the right of the southeast corner. The value of the (0,0) cell corresponds to the elevation for the world point at the northwest corner. The value of the (width,height) cell corresponds to the elevation for the world point at the southeast corner. Since the DTED data grid cells are not infinitesimally small, it is not possible to get the true elevation for the point. Interpolation of the elevation based on the corners of the grid cell that the world point occupies yields an approximation. An assumption is made that the grid cell will not be perfectly flat.

Given the grid location of the world point, the values of the four corners of the grid cell are retrieved from the DTED cell data. The fractional portion of the grid location of the world point is then used to calculate the weights for the four corners.

It is important to note it is not possible to require data from another DTED data cell. Each DTED data cell replicates the data of adjacent data cells along its border.

Exemplary Formula:

g(x, y)=the data within the DTED cell that corresponds to the grid location (x, y)

f(x, y)=elev

e₁=g(└×┘, └y┘)

e₂=g(└×+1┘, └y┘)

e₃=g(└×┘, └y+1┘)

e₄=g(└×+1┘, └y+1┘)

dₓ=1−(×−└×┘)

d_{y}=1−(y−└y┘)

elev=└dₓd_{y}e₁, +dₓ(1−d_{y})e₂+(1−dₓ)d_{y}e₃+(1−dₓ)(1−d_{y})e₄┘

NOTE: ∀dₓ, d_{y} [symbol] , [0,1]→dₓ; d_{y}+dₓ(1−d_{y})+(1−dₓ)d_{y}+(1−dₓ)(1−d_{y})=1.0

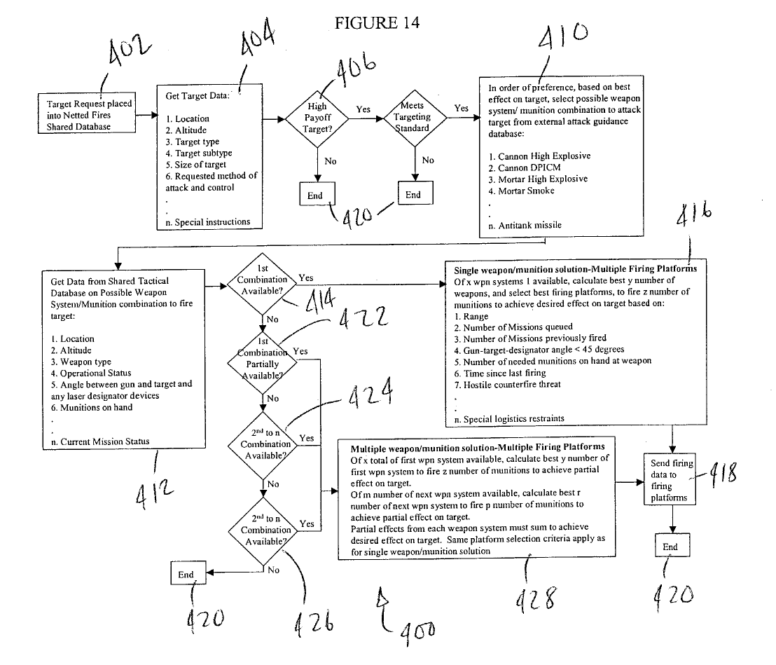

In FIGS. 14-22, there is shown another exemplary embodiment of the command and control system containing a collection of services, algorithms, methods, and representations, within a component, that allow a user to perform a netted fires functionality containing network processing of fire missions with encoded modifiable fire control processes and automated utilities for processing of fire missions. Such a system is particularly applicable for use in military planning and command and control, and for homeland security operations. When used for homeland security operations, lethal responses and weapon-target pairing are replaced by emergency response assets, in response-threat pairing. The architecture or the components used remains the same, but external data can be different.

The netted fires component 400 includes traditional weapon target pairing algorithms for both indirect fire weapons, such as mortars, cannons, and rockets, and also, other available weapon systems on the battlefield, such as tanks, anti-tank missiles, attack helicopter, photo bombers, and other direct fire weapons. As such, this algorithm accounts for and uses the effects of both direct and indirect fire weapons. The algorithm also uses the individual weapon systems munitions effects for direct and indirect fire weapon systems, rather than a weapon-only based effect, as is typically done in traditional algorithms used for this purpose. Finally, this algorithm allows for achievement of total desired target effects using the combined effects of multiply different weapon systems/munitions combinations, which traditional algorithms do not do.

Referring now to FIG. 14, the weapon target pairing method steps of the netted fire component 400 are explained in greater detail. In step 402 a target request is placed into the netted fires shared database. In step 404, target data is gotten from the shared database. This target data may include data pertaining to location, altitude, target type, target subtype, size of target, requested method of attack and control, and other data types and/or special instructions. In step 406 it is determined whether the target is a high payoff type target and in step 408 it is determined whether the target requested meets the targeting standards. If both of these decisions are answered in the affirmative, the process moved to step 410 in which in order of preference, based on best effect on target, a selection is made of the possible weapons system/munitions combinations that can be used to attack a target from an external attack guidance database. For example, these weapon systems may include cannon high explosives, cannon DPICM, mortar high explosives, mortar smoke, anti-tank missiles, or the like.

Once the selection of possible weapon system/munitions combinations are selected, additional data from the shared technical database on possible weapon systems/munitions combinations are selected to fire on the target in step 412. This data includes location, altitude, weapon type, operational status, angle between gun and target in any laser designator devices, munitions on hand, current mission status, and any other pertinent data or constraints. A check is made to determine whether the first combination is available in step 414. If the first combination is available the method moves to step 416 in which single weapons/munitions solution-multiple firing platforms are determined. For example, of X weapon Systems, if one available, calculate best Y number of weapons, and select best firing platforms, to fire Z number of munitions to achieve the desired effect on a target based on selected criteria. This selected criteria can include range, number of missions cued, number of mission previously fired, gun target designator angle list and 45 degrees, number of needed munitions on hand at weapon, time since last firing, hostile counter fire threat, special logistics restraints, and the like. Once this has been determined the method proceeds to step 416 in which the firing data is sent to a firing platform, whereupon the process ends in step 420.

If in the event in step 414 the first combination is not available, the process determines whether the first combination is partially available in step 416, or if the second to N combination is available in step 418 or if the second to N combination is available in step 420. If none of steps 422, 424, and 426 are available the process ends. If however any of steps 422, 424, or 426 are answered in the affirmative, the process proceeds to step 428 in which multiple weapon/munitions solutions-multiple firing platforms are calculated. In this step, for example, of X total of first weapon systems available, the best Y number of first weapon systems to fire Z number of munitions to achieve a partial effect on target are calculated. Of M number of next weapon systems available, the best R number of next weapon systems to fire P number of munitions to achieve partial effect on weapon is also calculated. Lastly, partial effects from each weapon system must sum to achieve the desired effect on the target. The same platform selection criteria apply as for single weapon/munitions solutions as in step 416. Once this has been calculated, the process proceeds to step 418 in which the data is sent to the firing platform where upon the process ends at step 420.

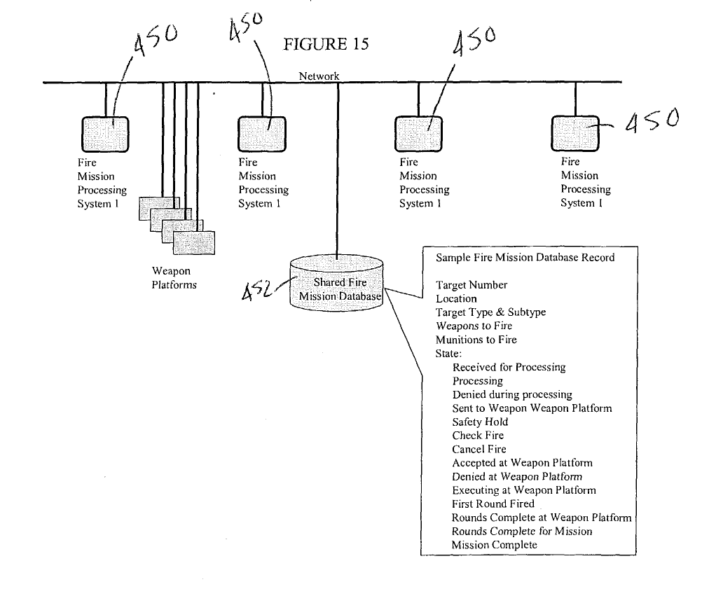

In FIG. 15 there is shown an automated process wherein the current processing state of any fire mission within the network, on any C3Core System 100 in the network, may be identified, observed, and modified from any machine on the network. Each fire mission processing system 450, comprising a portion of the C3Core System 100, has a local copy of the shared fire mission database 452. Any of the fire mission processing systems 450 may act as the actual server for the database. All of the fire mission processing systems 450 and weapon platforms on the fires network, if they have permission, can post changes to the database. Changes are posted to the shared fire mission database 452 by the system acting as the server at the time of posting. All other systems receive only the change, which is transmitted as a database “insert” or “update.” At a user-selectable time interval, a database synchronization is performed to insure that all systems have the same data. Since all the systems have the same data, and all are assumed to have permission, all can monitor the mission status (see sample fire mission database record), and can perform actions locally to modify the database record for a mission. As shown in FIG. 15, a sample fire mission database record may contain the following information: target number, location, target type and sub-type, weapons to fire, munitions to fire, and the following states: receive for processing, processing, denied during processing, sent to weapon platform, safety hold, check fire, cancel fire, accepted at weapon platform, denied at weapon platform, executing at weapon platform, first round fired, rounds complete at weapon platform, rounds complete for mission, and mission complete.

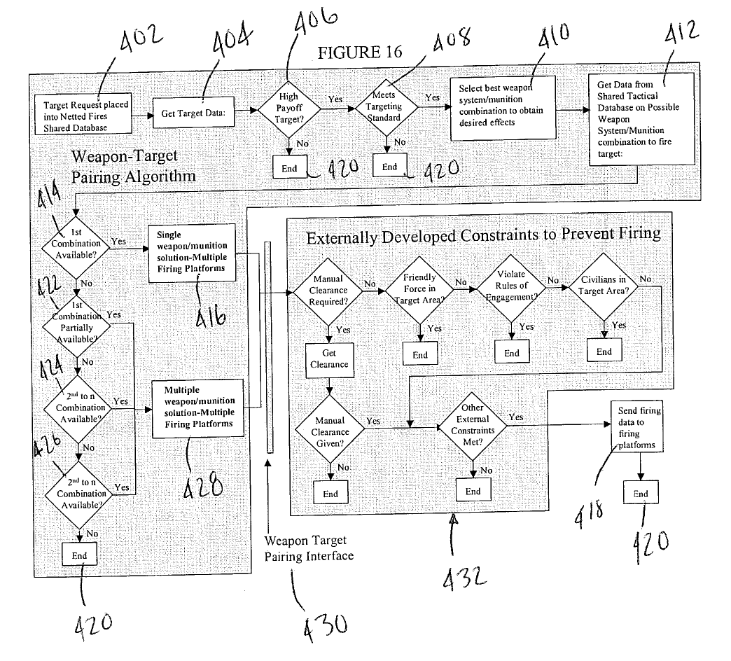

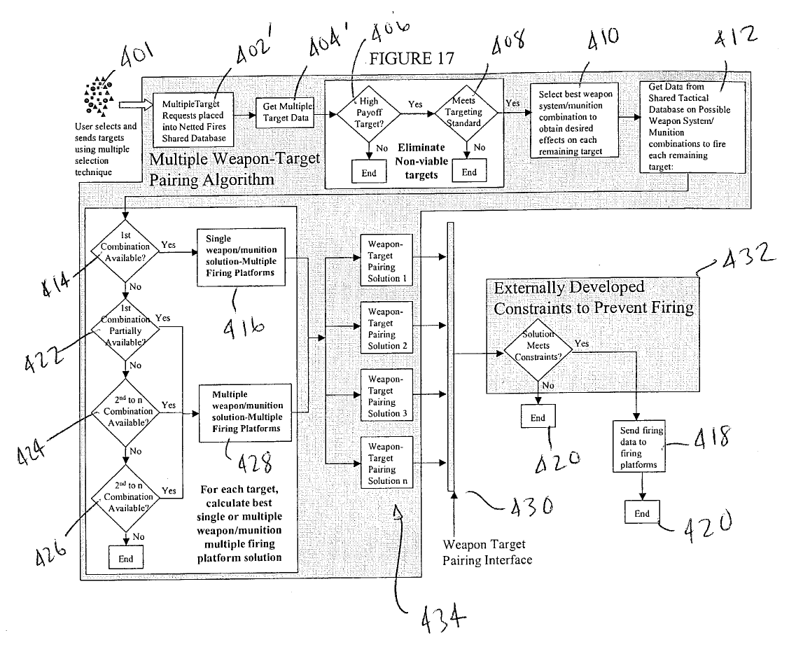

Referring now to FIG. 16, a process whereby externally developed automated algorithms for determining whether it is safe to fire, or whether other constraints should prevent firing, are integrated into the implementation framework of the netted fires component 400, such that firing can be blocked until the constraints or safety factors are no longer present or required. In between the single and multiple firing platforms selection steps 416 and 428 and the send fire data to firing platforms step 418, a weapon target pairing interface 430 and an externally developed constraints method to prevent firing 432 is inserted. The externally developed constraints to prevent firing step 432 can be developed by third parties to prevent the execution of a firing solution developed using the weapon target pairing algorhythm as discussed in connection with FIG. 14. These constraints usually are formulated in terms of safety considerations, rules of engagement, manual clearance of targets, friendly proximity, and other similar constraints. An interface 430 is provided to the developers, which allows them to use the output from the weapon target pairing as a starting point, and then to apply whatever constraints desired to the output. Other interfaces, possibly to the same application framework, but also to other application frameworks, allow the developers to obtain the information they may need about friendly forces proximity, civilian location, rules of engagement, and the like, and place this data into their algorithms. The algorithms that operate on the output from the weapon-target pairing component, and the data obtained concerning constraints, to determine whether the constraints have been met. If the constraints have been met, the mission may be fired. If the constraints are not met the mission is ended. At implementation, there is also a facility to override the constraints, which requires a human in the loop, with clear tracking of responsibility for making the decision to override.

Referring now to FIG. 17, a process whereby users may, with a single user input, select large numbers of individual targets for batch processing, automated assignment of weapon systems and munitions to target, and automated firing of weapons is shown. One important aspect of this embodiment of the invention is the ability of a user to perform multiple target selection via a pointing device, or the like, and then being able to send all selections to a targeting process simultaneously. In the case of the C3Core system, a drag box may be used to select all targets within a box. This is shown in step 401 of FIG. 17. All the selected targets can then be transmitted with a single user action, called the CFF (call to fire), menu choice. Once transmitted, the targets are placed into a netted fires shared database as schematically represented in step 402'. If the system is functioning in full automatic mode (no user in the loop), then all targets are processed according to the sequence shown in FIG. 17, starting with the selection of multiple target data step 404'. If the system is in non-automatic mode (user in the loop), the user will first group the targets, again with a drag box, and then pass the batch of targets forward to the weapon-target pairing algorhythm for processing. One of the differences between disembodiment and the embodiment depicted in FIG. 14 is that a plurality of weapon target pairing solutions 434 are developed and passed to the weapon target pairing interface 430 for further processing.

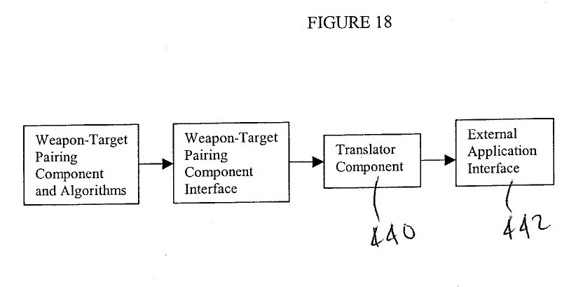

In FIG. 18 there is shown a componentized functionality and portability aspect of the invention which allows a component to be removed from the C3Core implementation framework 100 and inserted into other external implementation framework for reuse in fire control applications. This aspect of the invention is accomplished via the weapon target pairing interfaces described in FIGS. 15 and 16. The interface is constructed in such a manner that within the C3Core architecture 100, any component requiring the services of a weapon target component, and which complies with the implementation standards for the architecture, can access the component. If the component is required to be used outside the architecture 100, as with another application framework, the component and interface are provided with a translator component 440, which allows communication between the weapon target pairing component and external application 442.

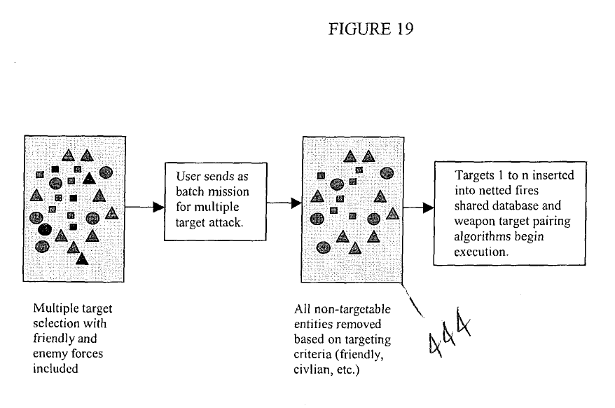

Referring now to FIG. 19, a process is shown that allows the selection of a large array of hostile targets for attack while filtering out friendly or other non-targetable entities, the algorithms which perform this multi-target function, multi-weapon system pairing in order to obtain optimal target-weapon system pairing for large target arrays. This component is the weapon pairing component described elsewhere in the application. The process uses the embodiment described in connection with FIG. 17 for the multiple target selection and batch processing steps, but adds the feature of removing, prior to sending the targets for batch processing, all non-targetable entities. This is shown in step 444. These entities would include friendly forces, civilians, and other targets prohibited by the rules of engagement. This process is required for targeting of multiple large target arrays using the techniques described in connection with the embodiment of FIG. 17 because the use of a drag box for selection of many targets often includes a number of non-targetable entities. This speeds the entire multiple target weapon pairing process as well, since it eliminates many potential targets before the addition of the targets to be netted fires shared database 402 prime and subsequent execution of weapon-target pairing and external constraint 432 algorithms.

Attack guidance is traditionally developed as an array of weapon systems, munitions types, and quantities of munitions types to be fired at different types of targets. The array usually is fairly static for a given phase of a tactical operation, and is based on expectations of the composition and intentions of a hostile force. However, if the composition and intentions of a hostile force do not happen to be what was expected, the attack guidance is frequently not updated to reflect the differences. This leads to a mismatch of preferred weapon systems, munitions types, and quantities against hostile target types. In the worst case scenario, there may be no weapon-target pairing solution if the attack guidance is inappropriate. In most cases, however, one finds that the attack guidance provides a solution which provides overkill, or more frequently, underkill on the target.

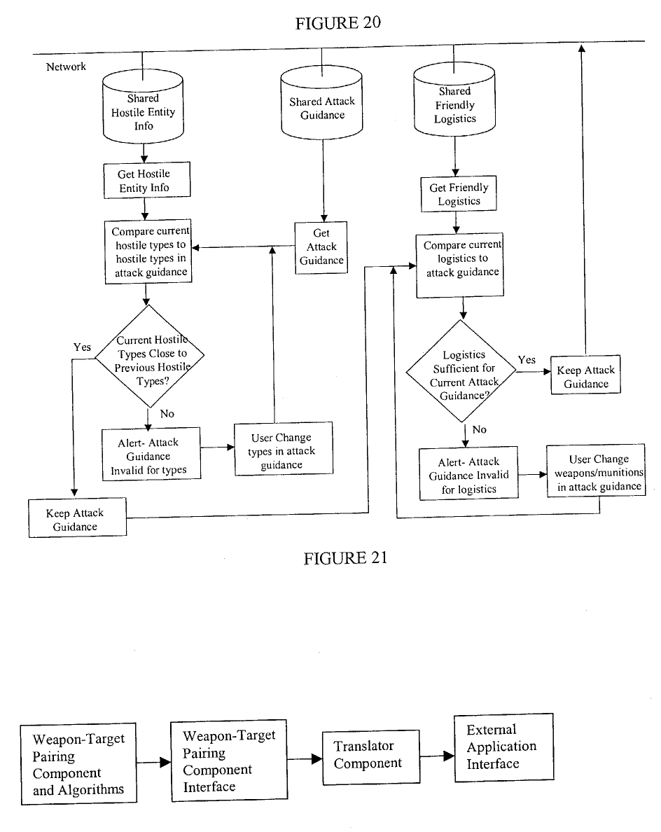

In FIG. 20 a monitoring process is depicted that compares the current attack guidance weapon systems, munitions types, and quantities against the current array of known hostile entities in the battlespace. The monitoring can be done continuously, which is inefficient in terms of computer resource usage, or can be done at periodic intervals specified by the user of the process. Typically, the periodic interval technique is used. The entire process is automated, allowing the user to focus on other aspects of battle management.

In practice, prior to the start of an engagement, a preliminary attack guidance array or matrix is developed and published based on intelligence that is known about a hostile force. Once a system using the process has been activated within the battle, it will compare its published attack guidance against the current list of hostile entities that are contained in a shared common operational picture database 460. As long as the hostile entities are within a specified range of congruence with the original intelligence, the attack guidance remains valid 468. However, as soon as sufficient 466 divergence between initial intelligence 462 used in developing attack guidance 464 and the current list of hostile entities, an alert is issued to the user that the attack guidance requires modification.

Besides monitoring the appropriateness of attack guidance with respect to types of hostile entities, the process also monitors friendly logistics states to ensure that sufficient weapons, munitions types and quantities are on hand to satisfy current attack guidance. If sufficient weapons, munitions types and quantities are not on hand to satisfy the current attack guidance, the user is again issued an alert that the attack guidance requires modification.

In FIG. 20 there is shown a system, algorithms, and services which perform target assessments within CDAS, and comparison of target arrays within current attack guidance. These systems, algorithms, and services also provide advice to users for changing attack guidance when the target array is not appropriate to current attack guidance. This component is depicted elsewhere in this application as the wizard tab.

Traditionally, attack guidance is used to assign a specific weapon system 480 and number and type 482 of munitions to attack a given target type and subtype. Normally it is laid out in a matrix with weapon systems and munition types and quantities on one axis, and the target type and subtype on the other axis. The weapon systems and munitions types and quantities will typically only be indirect fire weapon systems, and are generally assigned by the user in order of priority of attack. Effectiveness of the weapon and munitions against the target is a matter of user judgement. This is a largely manual process, typically done on paper and then entered into an automated fire control system.

In FIG. 21, there is shown the system and services which allow users to specify weapon systems and munitions with which to attack different types of targets in the form of attack guidance.

| | Target Types | | | |
|---|---|---|---|---|
| Attack System | Tanks | Infantry | Artillery | Rockets |
| Artillery-DPICM 12 | 2 | 2 | 2 | 2 |
| Rocket-M77 6 | 1 | 4 | 1 | 1 |
| Mortar-High Explosive 24 | 4 | 1 | 4 | 4 |
| Artillery-High Explosive 18 | 3 | 3 | 3 | 3 |

Target Selection Standards such as the time between sighting of the target and the current time, target location error in meters, and the source of the target report are also developed manually and entered into an automated fire control system, generally into a separate matrix. These are used to determine whether the target is capable of being attacked in a manner that is within time and accuracy constraints of the attacking weapon systems.

High payoff targets are generally developed manually, and entered into an automated fire control system. These are used to determine whether the target is worthy of attack. For example, a single infantry foot soldier is not worthy of attack by artillery, whereas an artillery battery is worthy of attack.

The attack guidance system in C3Core 100 allows the user to specify high payoff targets, target selection standards, and attack guidance in a single matrix form. This can done for large combinations of target types and subtypes, and also allows the specification of direct and indirect fire weapons for attack versus only indirect fire weapons in traditional systems. The user can also allow the system to use stored weapons/munitions effectiveness values to determine the proper weapon/munition mix with which to attack targets, rather than selecting each combination. Target selection standards may be created by the user, but may also be generated by the system based on an external knowledge base containing displace/emplace times for various target types, as well as information on whether the targets are moving or stationary. High payoff targets are defined by the user.

In practice, the user makes all selections in a single session. He does not have to open multiple computing sessions or windows to define or alter attack guidance. This is unique in automated systems that attempt to use some concept of attack guidance. The automated attack guidance system described herein attempts to locate the right weapon/munition mix in order of priority when a target is received and processed for attack. If the first mix in order of preference is not available, based on weapon system or munition availability as determined by reading of logistics and maintenance states, the next preferred weapon/munition mix is automatically selected, and so forth. This is also a unique characteristic of this system as compared to traditional systems. Traditional systems require a manual intervention to select a weapon/muniton mix if the desired preference is not available.

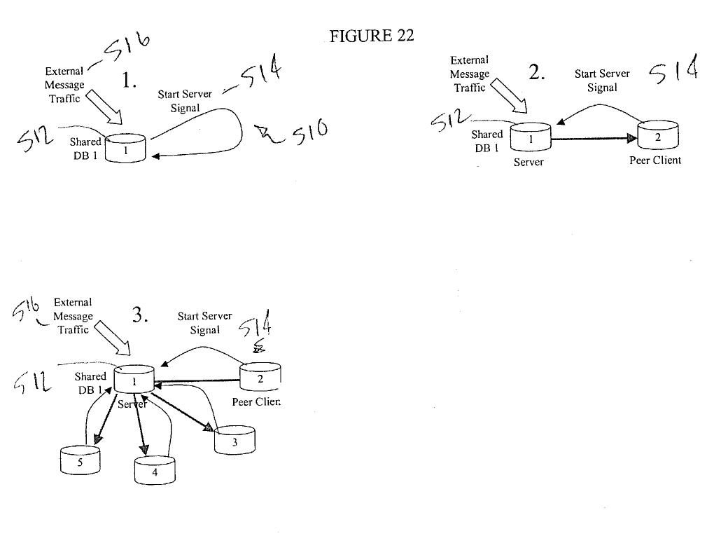

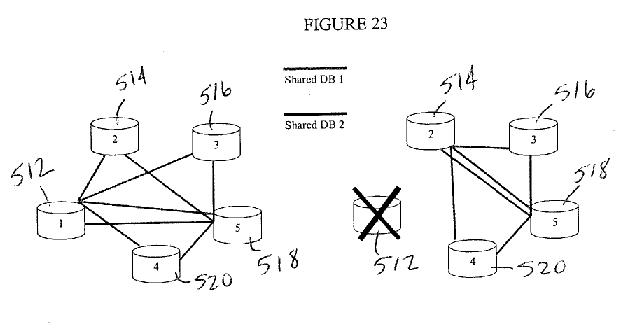

In FIGS. 22-23, there is shown Network Bridge services 501 supporting the communication between applications built within the C3Core architecture 100, which provide the capability to share synchronized databases 512 across a network of C3Core systems. This network bridge includes:

a. delivery of data in either peer-to-peer or client-server topology such that all data is duplicated on each system. The topology can be dynamically modified during operation to reflect peer-to-peer or client-server operation;

b. a system whereby data is redisseminated to all new network clients, which prevents the loss of data and allows for full data restoration and consistency; and

c. A self healing data network capability that allows synchronization of all C3Core systems, and allows any C3Core system to act as server for a synchronized database if the primary database server fails. This ensures that no data is lost if a server fails. The sharing and synchronization of databases using this capability is a unique invention, in that it functions as a serverless, peer-to-peer data sharing function, rather than traditional client-server functions. This allows for the shared data networking to be self-healing and damage tolerant. These components correspond to components [Db_tab] and [Network_bridge] described elsewhere in this application.

The Network Bridge 501 is a collection of processes and an embedded communication protocol which allows information and control to be shared between peers. In this context, a peer is another process, application or system which is connected through a network (i.e. TCP/JUDP) which either generates, consumes or shares client data.

This component provides both a server and peer control protocol that allows remote clients to identify other potential clients or sessions. A client is defined as a server which manages a collection of sessions. A session is a group of peers which communicate between themselves which is typically a subset of all potential peers. Sessions can be readily created or destroyed and clients are capable of joining or leaving existing sessions.

The Network Bridge 501 defines a control protocol which is capable of carrying a client defined protocol to carry client level control or data. The Network Bridge 501 can be implemented directly in an asynchronous communication model, or can support synchronous communication. The Network Bridge 501 requires a broadcast communication channel for the server control protocol, though clients may opt to use either UDP or TCP for peer communications.

Within the C3Core Component Architecture 100, many high level components may require distributed network communication to perform tasks such as collaborative planning, messaging, chat and white-boarding. The Network Bridge 501 provides a set of base functionality which allow these components to be readily built by abstracting a client from the basic control protocol. This abstraction facilitates rapid client development and provides a standard methodology and protocol which promotes component reuse and acceptance.

The Network Bridge 501component utilizes a Message Buffer which it transfers across the network and that could either contain control or client data. The Network Bridge 501 also defines three primary concepts, a server, a peer and a session. These terms are defined as follows:

Server: The server is implemented in the class [etwork_Session_Server]which performs two primary roles. The first is to identify and store the location of all other servers available within the network. This data is stored in a system address table. The second role of the server it to manage all sessions which are currently active.

Sessions: All Network Bridge sessions are implemented with the class Network_Session. A session is a named group of peers which form a collective in which data is shared amongst all peers. Any peer can either contribute data to the collective or receive information from the collective. Peers are able to create new sessions, join existing sessions or leave from a session.

Peer: A Peer is an entity which collaborates with other peers within the context of a session. Each peer “broadcasts” data to all other peers within a session or receive shared data from other peers. Client code which utilizes the Network Bridge can further define traditional roles such as “Server Peers” or “Client Peers”.

Primary Implementation Class Overview:

Class Socket: The class Socket is an incomplete base class which abstracts a UDP or TCP socket.

Class Message_Buffer: The class Message_Buffer encapsulates a character array which contains the actual packet of data which will be sent or was received from the network. The class provides two assessors which in which the client can obtain either the packet header information or the client provided data.

Class Network_Peer_Data: The Network_Peer_Data class is a collection of information regarding a peer on the network. This includes information such as the name of the peer, the network address of the peer and which port they are listening to.

Class Network Message_Queue: The Network_Message_Queue class provides a collection area for messages which are received from other peer. This class can be utilized directly in a asynchronous mode of operation. In this mode, messages are collected and stored, the client would then periodically clear the queue of messages. A synchronous mode of operation can be accomplished also, by deriving from this base call an overloading the pStore_Message method. Upon receipt of a message, this method is invoked. In the synchronous mode of operation, the client is notified of the receipt of every message.

Class Network_Session: The class Network_Session manages defines a named group of peers. The peers are able to create new sessions, join existing sessions or leave a session. All data which is sent to the session is provided to all other peers of the session which facilitates collaboration. This class also defines the control protocol which maintains consistency of peer communications. The peer who originates the session is called the session leader. When a new peer joins the session, the session leader automatically provides the new peer all pertinent information regarding all other peers who are part of the session. In the event the session leader leaves an active session, the leadership responsibility is automatically transferred to another peer within the session. When the last peer leaves a session, the session is automatically closed.

Class Network_Peer_Interface: All of the network peers of the Network Bridge have been either instantiated from or have been derived form the [etwork_Peer_Interface] This class has also been derived from the [etwork_Message_Queue]class to facilitate the receipt and storage of messages from other peers. It also supports the facility to disseminate information to other peers on the network. This class also defines the peer control protocol and methodology to allow peers to interoperate.

Class Network_Session_Server: The [Network_Session_Server]is responsible for two major tasks, the management of sessions and the identification of other peers on the network. When this class is instantiated, a broadcast message is sent out on the network, all other servers respond to this message by identifying themselves and provide information regarding which sessions are currently active and being managed. Client code can query the server to find out who the other servers are located at. It is also through the session server which client code can establish new sessions or join existing sessions. Each server on the network can identify all active sessions and automatically routes the request to join sessions to the appropriate session server. This class can be derived from to provide additional functionality such a notification of when sessions are created, joined to, or to control how or who is allowed to join. Persistent or habitual sessions can be created as an application requires.

As best seen in FIG. 22, the first picture depicts the start of a shared network. The system one starts and broadcasts a start server signal 514. No other systems respond that they are the server in this case. System one then assumes a role as server for the shared database 512, and listens for external message traffic that 516 that populates database 512.

Referring now to Section 2 of FIG. 22, the second system starts and broadcasts a start signal 514. The first system recognizes the signal and advises the second system that the first system is the server for the shared database 512. The second system assumes the role as a peer “client.” The first system opens a socket connection for the shared database 512 and shares or sends a copy of the database of the second system. Subsequent database changes posted as changes to the shared database 512, with periodic databases synchronizations. The first system creates a system address table within the shared database 512, which stores the order in which systems joining the session will assume the server role if the first system fails. The first system orders the second system in the system address table as the next system to assume the server role if the first systems fails, and shares the table with the second system.

Referring now to Section 3 of FIG. 22, assuming that other systems start in the same manner as shown and described in connection with the second system, the first system advises each that the first system is the server and sends a copy of the shared database 512 to each. Subsequent changes posted to the shared database 512, with periodic database synchronizations. The first system adds each new system to the system address table in order that they join the session and share the system address table with all the systems. In since each system has a local copy of the shared database 512 and the system address table, each system knows which system will become the server if the first system fails, the second system fails, and so on, and automatically begins the server role if the server is not available after a specified time. When the server changes, the previous server is removed from the system address table by the new server.

Referring now to FIG. 23, the Network Bridge 512 is shown maintaining shared data without loss if one or more of the systems fail while acting as the server. In a peer to peer network operation, with all systems functioning, the first system is the primary server for the shared database 512. Additional shared databases 514, 516, 518, and 520, are shown. The system is the primary server for the shared database 518. Systems are shown in the order that they joined the network session. The order of joining is the order in which systems will assume the server role in the case of a server failing. If the first system fails, the second system, then the third system, and so on assume the server role for the database 512 in order. If the fifth system fails, then the first system one then the second system, and so on, would assume this server role for the shared database 514.

Similarly, in a peer to peer network operation, having a server failure, the first system, which was the server for the shared database 512, is shown as failing. The other systems fail to receive the signal from the first system after it failed. After a specified time interval without communication from the first system, the second system assumes the role of server for the database 512, with no loss of data. As long as a single system remains operational, the shared database can be maintained, and restored to other systems which join or rejoin the session, without loss of data.

The Network Bridge 512 allows all databases, whether kept locally on a system where shared on a network to other systems, to be manipulated with a single user action. This is unique in this implementation of shared databases.

The Network Bridge allows all databases, whether kept locally on a system or shared on the network to other systems, to be manipulated with a single user action. This is unique in this implementation of shared databases. The concept of single user action to graphically manipulate databases within the C3Core architecture is shown in the figure below.

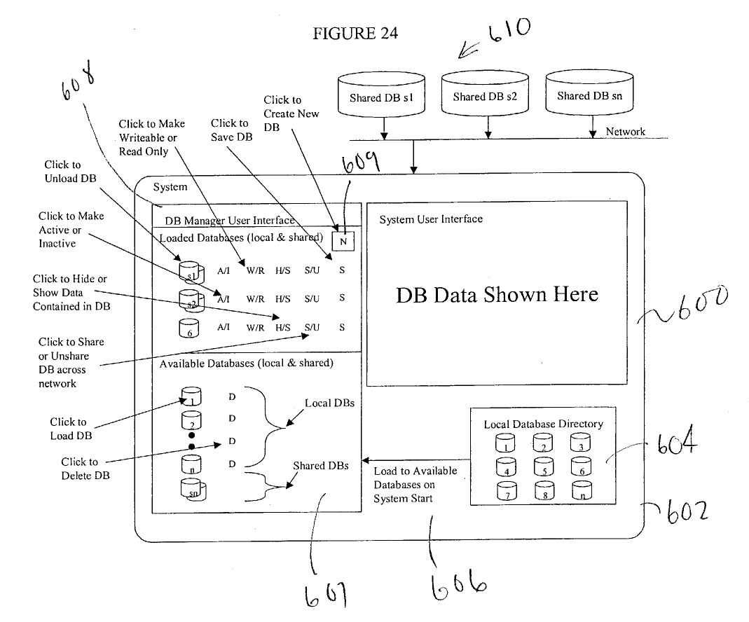

FIG. 24 shows a graphical database management technique which allows the creation, deletion, hiding, showing, loading, unloading and sharing of databases within a single user action with a pointing device or the like. The actual databases are managed within the backplane. FIG. 24 show a collection of local databases directory 604 which can be loaded into the system as available databases 606. The user may click on one of the database icons to load database into the available databases or may click on a different icon to delete the database. Shared databases may be included in this system. Similarly, a database manager user interface 608 is provided that depicts the loaded databases from the step 607 below. The user may click on various icons to make these loaded databases writeable or read only, active or inactive, with hidden or shown data, and/or to save the database. An additional icon is provided 609 for the user to create a new database. This graphical user system 600 is a virtual representation of the actual databases 610 which reside on the C3Core system. All actions taken by the manipulation of the graphical user interface are communicated to the databases on the system and appropriate action is taken.

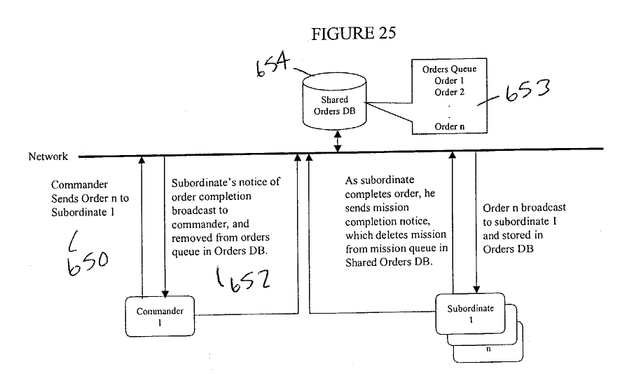

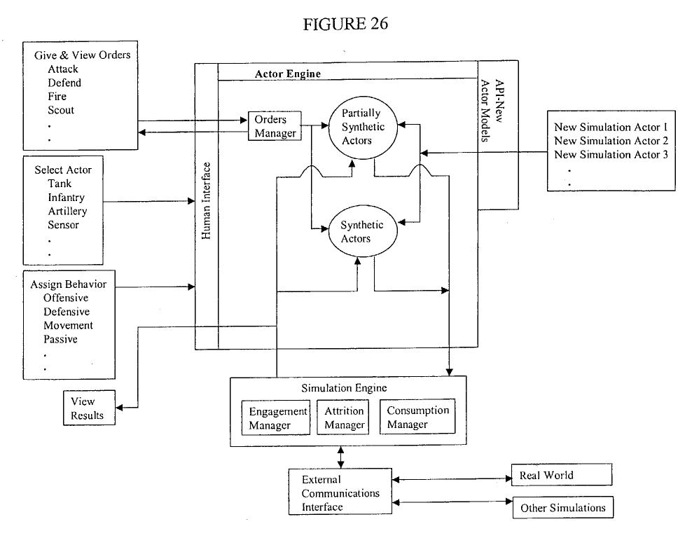

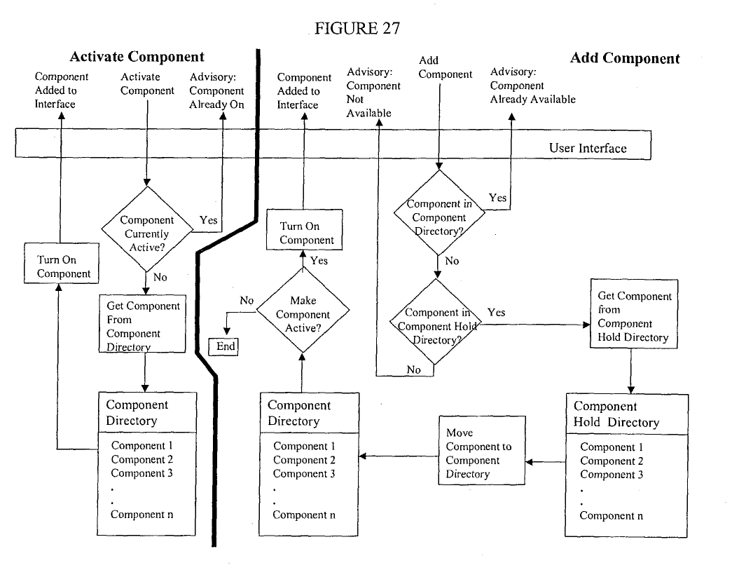

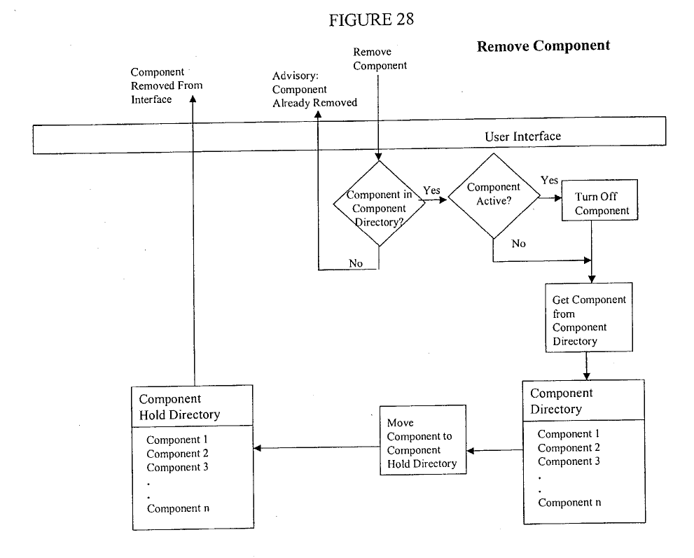

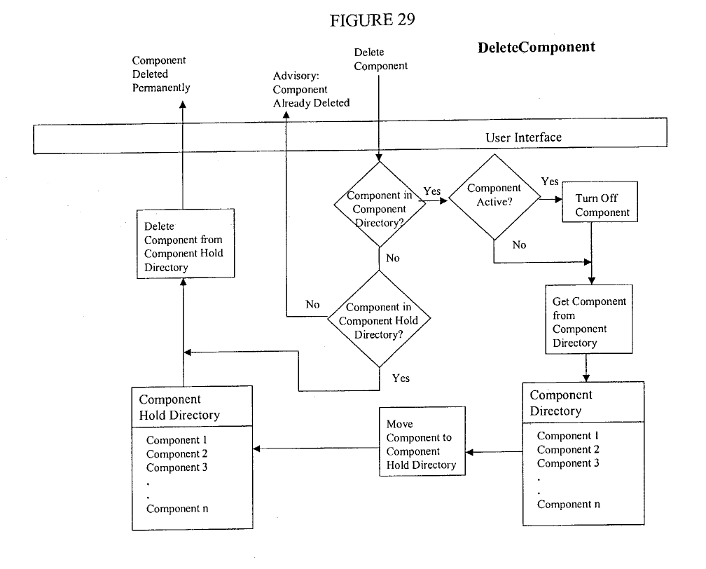

In FIGS. 25 and 26 there is shown a graphical user interface schematic having the capability provided by the shared databases and the Network Bridge shown in the embodiments of FIGS. 22 and 23 to give a commander and his subordinates the ability to post orders, sequences of orders, changes to orders, deletions of orders, and notification of completion of orders to a shared Orders DB. This is augmented with the capability, through a user interface 602, to select a subordinate unit from a map display, and then display all orders for the subordinate. When this capability is implemented, and the orders are displayed, a text display of the order is shown, along with a military graphic depicting the particular order. FIG. 25 shows the general flow of orders into the Orders DB from the commander and also the responses by the subordinate. FIG. 26 shows an actual implementation of the capability to further illustrate the text and graphic nature of the orders capability.

Referring now to FIG. 25, a commander sends an order N to a first subordinate in step 650. The order N is broadcast to the first subordinate and is stored in the orders database 654. The order N is received as a text message and an alert is broadcast of the new order. As the first subordinate views the text message, a graphical representation of the order is shown on a map display, as best seen in FIG. 26. Graphics correspond to military graphics to represent missions such as reconnaissance, attack, defense, and like. As the subordinate completes the order, he sends a mission completion notice which deletes the mission from the missions queue in the shared orders database 654. The commander or subordinates can obtain the orders queue 653 from the shared orders database 654 in order to view all relevant orders. The subordinate views only his orders. The commander views orders for all the subordinates. In practice or implementation, this is done by selecting a unit on a map display and viewing its orders via a menu choice. Once displayed, a commander can reorder or delete orders to the subordinates. He can also page through each set of subordinate orders, with the text and graphic being displayed automatically. Once this accomplished, the subordinates notice of order completion broadcasts to commander, and is removed from the orders queue 653 in the orders database 654.

As such, the system and services of the present invention allow the ordering and display in sequence of orders assigned to any real or simulated unit in C3Core 100. Also, it allows for the deletion and interruption of orders, and can be used in conjunction with real world operations, or for direction of simulated units during course of action simulation. All orders are shared across all systems and are visible to all systems. These plug-ins allow point and click assignment of orders to subordinate units in real world or simulation of course of action. Commands also cause both a text message frag order and graphic to be sent to the unit that is given the order. This component corresponds to the orders and orders bar plug-ins component that is described elsewhere in this application.

Referring now to FIG. 26, a reusable modeling and simulation system 150 there is shown reusable component within the architecture component repository, and which fully integrates into the extensibility framework of system 100. The component is a collection of methods and local data stores that allow a user to produce a dynamic and interactive simulation of a tactical course of action for both red and blue forces. The system includes:

a. an engine which defines actors which can be either fully synthetic, partially synthetic, or which can act as an interface for a human operator. The engine includes a capability to manage interactive orders simulation actors, and to perform attrition and ammunition consumption calculations for engagements during the simulation;

b. an engine which allows simulations and live exercises of command and control to be modeled simultaneously;

c. An engine which allows new simulation actor behaviors to added through a well-defined implementation interface;

d. A mechanism that allows dynamic assignment or reassignment of behavioral roles to an actor during the course of the simulation; and

e. A mechanism wherein current and pending orders or behaviors assigned to actors are represented graphically.

This component relates to the Sim_mgr component described in detail elsewhere.

The actor engine contains a repository of actors, which may be executable cognitive models of certain types of commanders, or computational models of weapon systems or units, or other types of models which can be inserted into the engine via the Application Programmer Interface (API). Some of the actors may be partially synthetic, in that a certain amount of user input is required in order to make the models perform their functions. This can be done via the human interface, primarily with the issuance of orders to the partially synthetic actors. The synthetic actors may be issued both orders and behaviors. After the fully synthetic actors have been assigned behavior, they are fully autonomous. Partially synthetic actors rely on behavior of the human user to perform their actions.

Behaviors may be reassigned during the course of simulation, as may orders. New actors may be added to the Actor Engine via an open API which defines the communications for new actors. Any third party developer wishing to add a new actor must simply ensure that the actor model conforms to the API. Both simulations and real world exercises may be modeled simultaneously with the engine. An external communications interface allows communications to real world systems and entities, and with simulation environments. In the case of real world communications, the interface would send and receive Joint Variable Message Format (JVMF) messages used by the military. In the case of simulation communications, the interface would send Distributed Interactive Simulation (DIS) or High Level Architecture (HLA) messages.

The models execute behavior within the actor engine. Their behavior, in terms of such actions as moving and shooting, as well as cooperation is passed to the simulation engine for modeling of engagement, supply consumption, and attrition. Results are then passed back into the actor engine for further reaction or action by the actor models, and viewing of results. If required, the results are also passed externally to real world or simulation systems.

Referring now to FIG. 27, 28, and 29, there is shown process and services which allow a user to manage the activation, loading, unloading, and destruction of the components in the architecture component repository to cause the display and creation of all tabs, monitors, and toolbars within the C3Core architecture 100 in order to create different applications using C3Core components. This is the tools component.

The processes and services allow a user, as opposed to a software developer, to create a customized application for many different uses. As a result, the user actually can build a number of greatly different applications given a set of components and the ability to add components, remove components, activate components, and delete components from within an application framework. Within the application framework, components reside within either a component directory or a component hold directory. These two directories together comprise the total sum of all components that can be used to build or modify an application. Components within the component directory may be either active or inactive. If active, the components will be functioning while the application is running, and if equipped with a user interface, the component user interface will also be shown. If inactive, the components will not be running, and will not show a user interface if so equipped. The user must activate the component in order to make the component work.

Components in the component hold directory cannot be activated before being added to the component directory. Once moved to the component directory, the user may then activate the components.

The component directory can be considered the current “toolbox” that the user has available to him within his application. For example, a logistics officer many have a set of tools that includes a map server, a terrain server, a communications server, and a logistics tracking component. These tools are the logistics officer application. If the logistics officer wants to create a different application, called “fire support,” he would remove the logistics tracking component from the component directory, and then move the fire support component into the component directory from the component hold directory. The user may also permanently delete a component from the application space by deleting it from the component hold directory. This would usually only be done by a person with the appropriate permission to perform this operation. The methodology for activating, adding, removing, and deleting components by a user in order to create different applications is shown in the following figures.

While the invention has been described by illustrative embodiments, additional advantages and modifications will occur to those skilled in the art. Therefore, the invention in its broader aspects is not limited to specific details shown and described herein. Modifications, for example, to algorithms or configurations of components, may be made without departing from the spirit and scope of the invention. Accordingly, it is intended that the invention not be limited to the specific illustrative embodiments, but be interpreted within the full spirit and scope of the appended claims and their equivalents.

What is claimed is:

1. A travel planning method comprising:
defining areas to be traversed;
specifying terrain feature characteristics;
identifying terrain feature characteristics within the area to be traversed;
applying terrain feature mobility modifier values including rank, multiplier or a combination thereof to the terrain feature characteristics; and
calculating, based on the terrain feature mobility values, one or more of the following: vehicle speed, travel time and travel distance.

2. The travel planning method of claim 1 further comprising:
performing a slope mobility analysis to determine relative mobility values of areas to be traversed; and
including the slope mobility values in the speed, time or distance calculations.

3. The travel planning method of claim 1 wherein calculating vehicle speed comprises:
specifying one or more vehicle speeds;
selecting a vehicle speed;
modifying the selected vehicle speed using the terrain feature mobility modifier values.

4. The travel planning method of claim 1 wherein calculating the travel time comprises:
specifying one or more vehicle speeds;
selecting a vehicle speed;
modifying the selected vehicle speed using the terrain feature mobility modifier values; and
dividing a distance to be traveled by the modified selected vehicle speed.

5. The travel planning method of claim 4 further comprising:
performing a slope mobility analysis to determine relative mobility values of areas; and
including the slope mobility values in the speed, time or distance calculations.

6. The travel planning method of claim 1 wherein calculating the travel distance comprises:
specifying one or more vehicle speeds;
selecting a vehicle speed;
modifying the selected vehicle speed by the terrain feature mobility modifier values; and
multiplying the modified vehicle speed by a time.

7. The travel planning method of claim 6 further comprising:
performing a slope mobility analysis to determine relative mobility values of areas; and
including the slope mobility values in the speed, time or distance calculations.

8. The travel planning method of claim 1 wherein at least a portion of the terrain feature characteristics are external to travel planning algorithms so they can be inputted/edited by a user.

9. The travel planning method of claim 1 wherein at least a portion of the vehicle characteristics are external to travel planning algorithms so they can be inputted/edited by a user.

10. A path traverse time calculation method comprising:
specifying vehicle characteristics;
defining areas to be traversed;
specifying terrain feature characteristics;
identifying terrain features within the area to be traversed;
applying terrain feature mobility modifier values to the terrain features; and
calculating path traverse time based on vehicle and terrain feature characteristics, modified by the mobility modifier values.

11. The path traverse time calculation method of claim 10 wherein the terrain feature mobility modifier values include rank, multiplier or a combination thereof.

12. The path traverse time calculation method of claim 10 wherein applying terrain feature mobility modifier values to the terrain features comprises:
assigning rankings to the terrain features based on their characteristics;
determining a dominant terrain feature among the identified terrain features by comparing terrain feature rankings; and
determining a mobility multiplier for the dominant terrain feature.

13. The path traverse time calculation method of claim 10 wherein one or more mobility modifier values are external to an algorithm comprising the path traverse time calculation method so they can be inputted/edited by a user.

14. The path traverse time calculation method of claim 10 further comprising:
dividing areas into cells;
calculating a path traverse time for each cell; and
determining a total path traverse time by summing the path traverse times of each cell.

15. The path traverse time calculation method of claim 10 wherein calculating path traverse time comprises:
assigning rankings to the terrain features based on their characteristics;
determining a dominant terrain feature among the identified terrain features by comparing terrain feature rankings
determining a mobility multiplier for the dominant terrain feature;
modifying a designated vehicle speed obtained from the specified vehicle characteristics by the mobility modifier; and
multiplying a distance by the modified vehicle speed to obtain a path traverse time.

16. The path traverse time calculation method of claim 10 wherein the vehicle characteristics are selected from the group consisting of width, road speed, cross country speed, ford depth.

17. The path traverse time calculation method of claim 10 wherein the terrain features are selected from the group consisting of road, river, trees.

18. The path traverse time calculation method of claim 17 wherein terrain features are ranked according to the relative speed at which they can be traversed.

19. The path traverse time calculation method of claim 10 wherein the terrain features include two or more features ranked in the following order:

| feature | rank |
|---|---|
| road | 1 |
| bridge | 2 |
| grassland | 3 |
| forest | 4 |
| swamp | 5 |
| river | 6 |

20. A terrain categorization method comprising:
extracting elevation values from an elevation raster for an area;
calculating a slope for each area;
assigning a relative mobility value to each area based on the calculated slope;
generating a polygon to define each area; and
categorizing the areas defined by the polygons according to relative mobility based on the calculated slopes.

21. The terrain categorization method of claim 20 wherein generating polygons comprises:
expanding each polygon from its edges to absorb smaller areas into proximate larger areas; and
shrinking each polygon inwardly from its edges.

22. The terrain categorization method of claim 21 wherein the polygons are expanded by n iterations and shrunk by n−2 iterations.

23. The terrain categorization method of claim 20 wherein a step algorithm is used to expand each polygon.

24. The terrain categorization method of claim 20 wherein each polygon is shrunk to approximately half the distance by which it was originally expanded.

25. The terrain categorization method of claim 20 wherein elevation values are extracted at geographical postings spaced apart in a range of about 30 meters to 100 meters.

26. A method of defining mobility cost factors comprising:
specifying terrain feature characteristics;
identifying terrain features within an area to be traversed;
modifying terrain feature characteristics by mobility modifier values;
performing a slope mobility analysis to determine relative mobility values of areas; and
creating mobility cost factors based on the modified terrain feature characteristics and the relative mobility values.

27. The method of defining mobility cost factors of claim 26 further comprising:
specifying vehicle characteristics; and
calculating path traverse time based on the vehicle characteristics and the mobility cost factors.

28. The method of defining mobility cost factors of claim 26 wherein the slope mobility analysis comprises:
extracting elevation values from an elevation raster for an area;
calculating a slope for each area;
assigning a relative mobility value to each area based on the calculated slope;
generating a polygon to define each area; and
categorizing the areas defined by the polygons according to relative mobility based on the calculated slopes.

29. The method of defining mobility cost factors of claim 26 further comprising:
expanding each polygon from its edges to absorb smaller areas into proximate larger areas; and
shrinking each polygon from its edges.

30. The method of defining mobility cost factors of claim 26 wherein the relative mobility values include passable or not passable.

31. The method of defining mobility cost factors of claim 26 wherein modifying terrain feature characteristics by mobility modifier values comprises:
specifying terrain feature characteristics; and
specifying terrain feature mobility modifier values including rank, multiplier or a combination thereof.

32. The method of defining mobility cost factors of claim 2 further comprising:
dividing areas into cells;
calculating a path traverse time for each cell; and
determining a total path traverse time by summing the path traverse times of each cell.

33. The method of defining mobility cost factors of claim 27 wherein calculating path traverse time comprises:
assigning rankings to terrain features;
determining a dominant terrain feature among the identified terrain features by comparing terrain feature rankings;
determining a mobility multiplier for the dominant terrain feature;
specifying vehicle characteristics;
modifying a designated vehicle speed obtained from the specidfied vehicle characteristics by the mobility modifier; and
multiplying a distance by the modified vehicle speed to obtain a path traverse time.

34. The method of defining mobility cost factors of claim 28 wherein a step algorithm is used to expand each polygon.

35. The method of defining mobility cost factors of claim 28 wherein each polygon is shrunk to approximately half the distance by which it was originally expanded.

36. The method of defining mobility cost factors of claim 28 wherein elevation values are extracted at geographical postings spaced apart in a range of about 30 meters to 100 meters.

37. The method of defining mobility cost factors of claim 27 further comprising:
specifying a travel time;
comparing the calculated path traverse time to the specified travel time, and if the specified travel time is greater than the calculated path traverse time, then repeating the time calculation process for one or more second areas adjacent to the first defined area;
adding the first calculated path traverse time separately to each of the second defined areas; and
repeating the process until the total time is approximately equal to the specified travel time, thereby determining the maximum distance of travel.

38. The method of defining mobility cost factors of claim 37 wherein the terrain characteristics are identified in an area extending to a distance approximately twice the maximum distance the vehicle can travel in a specified time.

39. The method of defining mobility cost factors of claim 37 wherein an eight-direction stepping algorithm is used to perform the calculation iterations.

40. The method of defining mobility cost factors of claim 37 wherein time summations containing retraversed areas are rejected.

41. The method of defining mobility cost factors of claim 37 wherein generating terrain characteristic mobility modifier values comprises one or both of the following:
performing a slope mobility analysis to determine relative mobility of areas; and
modifying terrain feature characteristics by mobility modifier values.

42. The method of defining mobility cost factors of claim 27 further comprising:
selecting a starting point and ending point;
calculating path traverse times for a plurality of paths from the starting point to the end point;
comparing the path traverse times calculated to one another; and
selecting the shortest path traverse time.

43. The method of defining mobility cost factors of claim 42 wherein calculating path traverse times for the plurality of paths comprises:
determining a center point of a line connecting the starting point to the end point;
generating mobility values for each cell along and to a specified distance from the line connecting the starting point to the end point;
generating paths through the cells;
calculating path traverse times by summing times to traverse each cell in a path.

44. The method of defining mobility cost factors of claim 43 wherein paths are obtained using an eight-direction step algorithm.

45. The method of defining mobility cost factors of claim 43 wherein the traverse times are calculated by creating paths simultaneously from the end point toward the starting point and from the starting point toward the end point until the two simultaneously created paths meet.

46. The method of defining mobility cost factors of claim 1 further comprising:
generating a plurality of polygons, each associated with a particular mobility cost factor;
expanding each polygon from its edges toward adjacent polygons to form mobility corridors.

47. The method of defining mobility cost factors of claim 46 further comprising:
specifying requirements for corridor characteristics; and
eliminating any corridors not meeting the corridor requirements.

48. The method of defining mobility cost factors of claim 46 further comprising:
specifying a direction of travel.

49. A method of determining visibility of a location from a vantage point comprising:
(a)specifying a vantage point A;
(b) specifying a point B of questionable visibility;
(c) moving an incremental distance along the ground from vantage point A toward point B to point A₁;
(d) calculating a slope of a line from vantage point A to point A₁;
(e) moving an incremental distance from point A₁ along the ground toward point B to point A₂;
(f) calculating a slope of a line from vantage point A to point A₂;
(g) save the greater of the slope of line AA₂ and the slope of line AA₁;
(h) repeat steps (c) through (g) until within a specified distance from point B;
(i) if the last saved slope is greater than the slope of a line from vantage point A to point B, then point B is not visible from vantage point A, and if the last saved slope is less than or equal to the slope of the line from vantage point A to point B, then point B is visible from point A.

50. The method of determining visibility of a location from a vantage point of claim 49 wherein the increments are in the range of about 20 meters to 40 meters.

51. A system for allowing networked processing of fire missions with fire control processes and automated utilities for processing of fire missions comprising:
automated weapon-target pairing processes which are capable of being integrated into an implementation framework during an operation of the system, the algorithms account for shared information about targets, available weapon systems, attack guidance, munitions effectiveness, target and weapon systems locations, attack angles, commander guidance on attack methods, logistics states, maintenance states, and munitions availability from databases available to the system.

52. The netted fire system according to claim 52, wherein the fire control processes are automatic processes whereby the current processing state of any fire mission within the system may be identified, observed, and modified from any computer in the system.

53. The netted fire system according to claim 52, wherein the weapon-target pairing processes are externally developed automated processes for determining whether it is safe to fire, or whether other constraints should prevent firing, can be integrated into an implementation framework of the netted fires component, such that firing can be blocked until the constraints or safety factors are no longer present or required.

54. The netted fire system according to claim 52, wherein users may select large numbers of individual targets for batch processing, automated assignment of weapon systems and munitions to targets, and automated firing of targets.

55. The netted fire system according to claim 52, wherein each component of the sytem has componentized functionality and is portability allowing the component to be removed from the implementation framework and inserted into other external implementation frameworks for reuse in fire control applications.

56. The netted fire system according to claim 52, further comprising processes that allow selection of large arrays of hostile targets for attack while filtering out friendly or other non-targetable entities, and processes which perform multi-target, multi-weapon system pairing in order to obtain optimal target-weapon system pairing for large target arrays.

57. The netted fire system according to claim 52, further comprising means for performing target assessment within CDAS, and comparison of target arrays against current attack guidance and means for providing advice to users for changing attack guidance when target array is not appropriate to current attack guidance.

58. The netted fire system according to claim 52, further comprising means for allowing users to specify weapon systems and munitions with which to attack different types of targets in the form of attack guidance.

59. Network bridge services supporting the communication between applications within a combat decision support system which provide the capability to share synchronized databases across a network comprising:
delivery of data in either peer-to-peer or client-server topology such that all data is duplicated on each system, the topology is dynamically modifiable during operation to reflect peer-to-peer or client-server operation.

60. The network bridge services of claim 59, wherein data is redisseminated to all new network clients, which prevents the loss of data and allows for full data restoration and consistency.

61. The network bridge services of claim 59, wherein the network is a self healing data network allowing synchronization of systems, and allowing any system to act as server for a synchronized database if a primary database server fails, whereby ensuring that no data is lost if a server fail; the network serving as a serverless, peer-to-peer data sharing function.

62. The network bridge services of claim 59, further comprising a graphical database management system which allows creation, deletion, hiding, showing, loading, unloading, and sharing of databases with a single user action with a pointing device; the databases being managed within an architecture backplane.

63. A system allowing the ordering and display in sequence of orders assigned to any real or simulated unit in a combat decision support system, comprising:
means for deletion and interruption of orders;
means for use in conjunction with real world operations, or for direction of simulated units during course of action simulation;
means for sharing orders across systems such that orders are visible to all systems;
means for permitting point and click assignment of orders to subordinate units in real world or simulation of course of action; and
means for causing both a text message frag order and a graphic to be sent to the unit giving an order.

64. A reusable modeling and simulation system of a combat decision support system which is a reusable component within an architecture component repository, and which integrates into a extensibility framework thereof, comprising
at least one component being a collection of methods and local data stores that allow a user to produce a dynamic and interactive simulation of a tactical course of action for both red and blue forces, comprising
an engine which defines actors which can be either fully synthetic, partially synthetic, or which can act as an interface for a human operator, the engine including a capability to manage interactive orders simulation actors, and to perform attrition and ammunition consumption calculations for engagements during the simulation.

65. A reusable modeling and simulation system of claim 64, wherein the engine allows simulations and live exercises of command and control to be modeled simultaneously.

66. A reusable modeling and simulation system of claim 64, wherein the engine allows new simulation actor behaviors to added through a well-defined implementation interface.

67. A reusable modeling and simulation system of claim 64, wherein the engine allows dynamic assignment or reassignment of behavioral roles to an actor during the course of the simulation.

68. A reusable modeling and simulation system of claim 64, wherein current and pending orders or behaviors assigned to actors represented graphically.

69. The network bridge services of claim 59, further comprising means for allowing a user to manage the activation, loading, unloading, and destruction of the components in the architecture component repository to cause the display and creation of all tabs, monitors, and toolbars within the architecture in order to create different applications using components.
